(19) United States
(12) Patent Application Publication
(10) Pub. No.: US 2008/0135461 A1
(43) Pub. Date: Jun. 12, 2008

(54) Dense medium separator

(76) Inventor: Paul A. Olivier, Dalat City (VN)

Correspondence Address: RUDOLPH J. BUCHEL JR., LAW OFFICE OF, P. O. BOX 702526, DALLAS, TX, 75370-2526, US

(21) Appl. No.: 11/999,460

(22) Filed: Dec. 4, 2007

Related U.S. Application Data
(60) Provisional application No. 60/873,181, filed on Dec. 6, 2006.

(51) Int. Cl. B03B 5/60

(52) U.S. Cl. 209/162

(57) ABSTRACT

The present invention is directed to a dense medium separator and methods for operating the separator and separating solids in a dense medium. A separator is presented with distribution and extraction zones at opposite ends. Solids enter the separator and medium is injected in the direction of the extraction zone at the distribution zone. The injected medium forms a float current that moves the lower density solids to the extraction zone which then overflows a weir and is harvested. A floats extraction device separates the lower density solids from the medium and recirculates the medium back into the injection stream. Between the distribution and extraction zones is a separation zone where higher density solids fall out of the float current and into/onto a sinks mover at the bottom of the separation zone. The sinks mover moves the higher density solids in a direction opposite to that of the flow direction to a recovery zone where they are harvested. A sinks recovery device separates the high density solids from the medium and recirculates the medium back into the injection stream. The sinks mover also creates counter-current in the medium which is also opposite the direction of the float current. Higher separation accuracies are achieved by establishing a vertical interval of unperturbed medium in the separation zone of the bath between the float current of the upper level and the counter-current and sinks mover in the lower level. There, the predominant force acting on the solids is the separation density, i.e., the difference between the density of a solid and the medium. Lower density solids (floats) will separate, unimpeded, upward into the float current where they are extracted at the extraction zone, while higher density solids (sinks) separate downward into the counter-current and on to the sinks mover, where they are recovered in the recovery zone.

### CROSS-REFERENCE TO RELATED APPLICATIONS

The present application is related to and claims priority from co-pending U.S. provisional patent application Ser. No. 60/873,181 entitled “Dense Medium Separator” and filed Dec. 6, 2006, and is incorporated by reference herein in its entirety.

### BACKGROUND OF THE INVENTION

1. Field of the Invention

The present invention relates generally to separation and separators. More particularly, the present invention relates to a dense medium separator and methods for operating the separator and separating solids in a dense medium.

2. Description of Related Art

Dense medium separation known in the relevant technological arts as a technique for separating particulate solids by their respective densities by immersing the particulates in a dense medium mixture. The dense medium is a suspension of fine particles in a liquid. The particulate solids to be separated are mixed with the suspension. During the separation process, the particulate solids will sink or float based on the difference between density of the particulate solids to be separated and the density of the suspension medium.

U.S. Pat. No. 5,373,946 to Olivier discloses a barrel separator for separating solid particles in two fractions using a suspension medium, the specific gravity of the medium being between the specific gravity of the particles of the two fractions. The separator is generally a scrolled barrel wherein said particles are separated into a float fraction and a sink fraction. The float fraction, as well as medium, stream towards one end of the scrolled barrel, while at the same time the scrolled barrel is rotated so as to move the sink fraction towards the opposite end of the scrolled barrel and furthermore so as to bring said sink fraction into a second scrolled barrel attached to and communicating with the first barrel. A curtain is preferably positioned at or near the junction of the two barrels; that is, between that end of the first barrel nearest to the second barrel and that end of the second barrel nearest to the first barrel. The curtain serves to prevent the passage of the float fraction into that part of the second barrel located between the curtain and the end opposite to the end adjacent to the first barrel. The float fraction as well as medium is evacuated at the end of the first barrel opposite to the end adjacent to the second barrel, while, as a result of the rotation of the second barrel, the sink fraction is evacuated at the end of the second barrel opposite to the end adjacent to the first barrel.

U.S. Pat. No. 6,530,484 to Bosman discloses a dense medium cyclone separator. The cyclone separator generally comprises an inlet chamber having a tangential raw material feed inlet, a vortex finder extending into the inlet chamber, and defining a low gravity fraction outlet for a low gravity fraction of separated material, a conical section opposed to the vortex finder extending and converging in a direction away from the inlet chamber, an outlet chamber extending co-axially with the conical section and in a direction opposed to the inlet chamber and providing an unobstructed flow path to a high gravity fraction outlet for a high gravity fraction of separated material being disposed generally tangentially relative to the outlet chamber. Raw feed introduced into the inlet chamber through the tangential raw material feed inlet, will swirl circularly in the inlet chamber zone resulting in a separation of denser (high gravity) and less dense (low gravity) particles.

### BRIEF SUMMARY OF THE INVENTION

The present invention is directed to a dense medium separator and methods for operating. Dense medium separator separation generally refers to a quiescent bath wherein the density of water is changed by means of fine particles in suspension.

The presently disclosed dense medium separator can be subdivided by function into four zones: a distribution zone, a separation zone, a recovery zone, and an evacuation zone. The suspension medium is injected into the separator across a wide area of the distribution zone and solids are introduced to the bath (smaller solids are injected with the medium and larger solids are introduced to the surface). In accordance with one exemplary embodiment, the distribution zone is rather shallow, approximately the same depth as the weir is high at the end of the evacuation zone (approximately one-fifth the depth of the separation zone is an optimal ratio for many applications).

The medium and solids in the bath flow from the shallow distribution zone in the direction of the weir and into the separation zone. The separation zone is approximately five times as deep as the weir height or distribution zone (measured from the surface of the bath to the top of the sinks mover, e.g., scrolls, belts or augers). In the separation zone, the floats in the float current created by the medium from the injector nozzles, maintain constant momentum toward the evacuation zone, and eventually they enter the overflow zone, while sinks fall out to the bottom of the separation zone into the recovery zone.

In the separation zone, a counter-current movement is generated by the action of a sinks mover that pulls the sinks along the bottom of the separator in the opposite direction of the float current, but without lifting the sinks. Lifting introduces turbulence that destroys the accuracy of separation. The sinks are moved horizontally along the bottom of the bath until they are completely outside the separation zone and then lifted up and out of the bath using belts, augers or pumps, etc.

Once the floats have traveled the full length of the separation zone, they then enter the evacuation zone. In accordance with some exemplary embodiments of the present invention, in the evacuation zone, a floats evacuation trough is formed in the separator with a two-fold decrease in bath width. For example, a 10-foot separator would have an overflow weir 5 feet in width, a 5-foot separator would have an overflow weir 2.5 feet in width, and so forth. Coincidentally, the bath depth decreases by five-fold to a fifth (20%) the depth of the separator zone. A gradual decrease in bath width over a 60 degree angle (and the simultaneous decrease in the bath depth) assures that float particles will rapidly exit the separator into the overflow zone. The height of the weir must be at least two thirds of the diameter of the largest float to ensure that all the floats are lifted out of the evacuation zone and into the overflow zone.

One advantage of such of the presently described invention lies in the accuracy of separation. Using the present separator, a good carrot of a density of 1.050 can be easily separated from a partially dehydrated carrot of a density of 1.053. Similarly, a bad sugar beet of a density of 0.997 can be easily separated from a good sugar beet of a density of 1.002. A potato with a high solids content can be easily separated from a potato of a low solids content. Further distinctions can be made within potatoes of a high solids content to specify with great precision their residence time within a frying pan. Bad or diseased potatoes of a density below 1.04 can be eliminated from a potato canning line. In the separation of plastics, plastics of a density of 1.02 can be easily separated from plastics of a 1.04 density. Through the use of alcohols or oils to lower the density of water, it is even possible to separate plastics of densities less than 1.0.

Consequently, a device for separating solids by density as discussed above comprises a quiescent bath of medium, said quiescent bath comprises at least a separation zone wherein a fraction of float solids are separated from a fraction of sink solids, a medium distribution device to generate a float current of medium in a first direction of the quiescent bath, a solids distribution device to deposit solids into the quiescent bath, the solids comprising the fraction of float solids and the fraction of sink solids, an outflow device to receive at least a portion of the float current and to outflow the at least a portion of the float current and the float solids from the quiescent bath, a sinks solids device to move the sink solids in a direction opposite the float current, and a lift device to lift the sink solids from the quiescent bath.

Alternatively, a dense medium separator for separating solids by density comprises a bath for holding medium, the bath having a separation zone for separation of solids by density, an injection device to generate a float current of medium in a first direction of the bath, a vibration table to tamp a heterogeneous distribution of solids, the solids comprises a fraction of sinks and a fraction of solids, a slide to redirect the solids, a weir to evacuate the floats from the bath, a sinks mover to move the sinks horizontally, in a direction opposite the float current, and a lift device to recover the sinks from the bath.

In accordance with other exemplary embodiments of the present invention, a method for separating solids by density comprises generating a floats current in a first direction of a quiescent bath of medium establishing a counter-current below the float current, the counter current being substantially opposite to the first direction depositing a fraction of float solids and a fraction of sink solids in the float current extracting the float solids from the float current recovering the sink solids from the counter-current.

### BRIEF DESCRIPTION OF THE SEVERAL VIEWS OF THE DRAWINGS

The novel features believed characteristic of the present invention are set forth in the appended claims. The invention itself, however, as well as a preferred mode of use, further objectives and advantages thereof, will be best understood by reference to the following detailed description of an illustrative embodiment when read in conjunction with the accompanying drawings wherein:

FIG. 1 depicts a cross-sectional top view of a dense medium separator in accordance with an exemplary embodiment of the present invention;

FIG. 2 depicts a cross-sectional side view of a dense medium separator in accordance with an exemplary embodiment of the present invention;

FIG. 3 is a cross-sectional side view that depicts the individual zones of the presently described separator in accordance with an exemplary embodiment of the present invention;

FIG. 4 depicts a cross-sectional side view of a dense medium separator that uses a belt rather than an auger to recover sinks on the bottom of the separation zone in accordance with an exemplary embodiment of the present invention;

FIG. 5 is a cross-sectional side view of the exemplary dense medium separator shown in FIG. 8 in accordance with another exemplary embodiment of the present invention;

FIG. 6 is a cross-sectional side view of the exemplary dense medium separator showing the opposite side of the exemplary dense medium separator shown in FIG. 8 in accordance with another exemplary embodiment of the present invention;

FIG. 7 is a front view of the exemplary dense medium, wherein the front is the evacuation end of the exemplary dense medium separator shown in FIG. 8 in accordance with another exemplary embodiment of the present invention;

FIG. 8 is an oblique view of separator 200 in accordance with another exemplary embodiment of the present invention;

FIG. 9 depicts an enlarged view of distribution volume 222 in accordance with another exemplary embodiment of the present invention;

FIG. 10 depicts an enlarged view of the evacuation side of separator 200 in accordance with another exemplary embodiment of the present invention; and

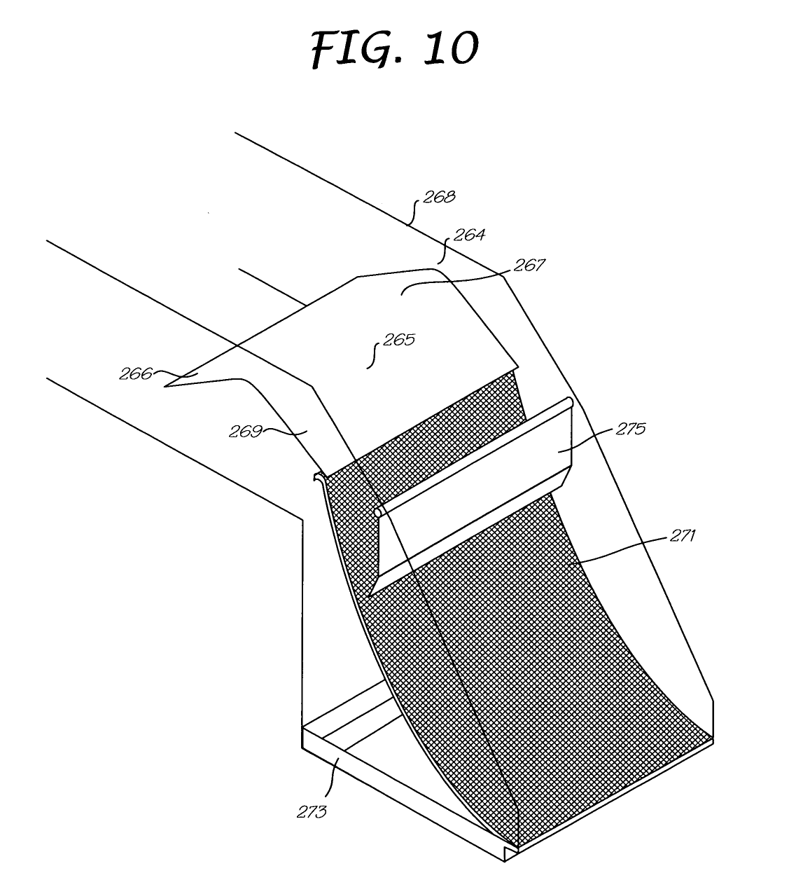

FIG. 11 is a chart of terminal velocity rates for solids based on their respective densities.

Other features of the present invention will be apparent from the accompanying drawings and from the following detailed description.

### DETAILED DESCRIPTION OF THE INVENTION

Element Reference Number Designations

| | |
|---|---|
| 100: | dense medium separator |
| 102: | medium injection pipe |
| 104: | injection nozzles |
| 106: | separator supports |
| 110: | floats |
| 112: | sinks |
| 114: | medium |
| 120: | distribution zone |
| 122: | shallow distribution volume |
| 130: | distribution device |
| 132: | solids distribution vibrating table |
| 134: | solids distribution slide |
| 140: | separation zone |
| 142: | separation volume |
| 146: | sinks mover motor |
| 148: | sinks mover (auger) |
| 149: | sinks mover (paddle belt) |
| 160: | evacuation zone |
| 162: | evacuation zone volume |
| 164: | weir |
| 166: | tapered evacuation bottom |
| 168: | evacuation trough sidewall |
| 169: | evacuation sidewall (open) |
| 176: | floats recovery trough |
| 178: | floats recovery device |
| 180: | sinks recovery zone |
| 182: | sinks recovery hopper |
| 184: | recovery device |
| d_{b}: | bath depth |
| d_{dz}: | distribution zone depth |
| d_{sz}: | separation zone depth |
| d_{w}: | weir (overflow) depth |
| h_{rz}: | recovery zone height |
| I_{dz}: | distribution zone length |
| I_{ez}: | evacuation zone length |
| I_{rz}: | recovery zone length |
| I_{sz}: | separation zone length |
| wₛ: | separator width |
| w_{w}: | weir width |
| α: | evacuation zone narrowing |
| angle | |
| β: | evacuation trough angle |
| γ: | evacuation zone taper angle |
| 200: | dense medium separator |
| 202: | medium injection pipe |
| 206: | separator supports |
| 207: | pump |
| 208: | medium tank |
| 209: | tank supports |
| 210: | floats |
| 212: | sinks |
| 214: | medium |
| 220: | distribution zone |
| 221: | distribution zone bottom |
| 222: | shallow distribution volume |
| 230: | distribution device |
| 232: | solids distribution vibrating table |
| 234: | solids distribution slide |
| 236: | outfall edge of slide |
| 238: | upper crest of distribution slide |
| 240: | separation zone |
| 242: | deep separation volume |
| 246: | sinks mover motor |
| 248: | sinks mover (auger) |
| 260: | evacuation zone |
| 262: | evacuation zone volume |
| 264: | weir |
| 265: | overflow barrier |
| 266: | tapered upstream side |
| 267: | barrier crest |
| 268: | evacuation sidewall |
| 269: | tapered overflow side (downstream) |
| 270: | floats recovery assembly |
| 271: | floats recovery dewatering device |
| 272: | floats transport |
| 273: | floats medium recovery basin |
| 275: | floats splash guard |
| 280: | sinks recovery zone |
| 282: | sinks recovery hopper |
| 284: | recovery device |
| 290: | sinks recovery assembly |
| 291: | sinks recovery dewatering device |
| 292: | sinks transport |
| 293: | sinks medium recovery basin |
| 294: | medium recovery pipe |
| 295: | sinks splash guard |
| 296: | sinks recovery device motor |
| 298: | sinks recovery device (auger) |

The present dense medium separator is an apparatus which utilizes a stable and uniform suspension medium for separating solids by their densities. The stability of the medium is greatly enhanced by the design and operation of the presently disclosed dense medium separator. Essentially, what is desired is the creation of a counter-current of suspension medium that forces less dense solids (floats) to travel in one direction and forces more dense solids (sinks) to travel in the opposite direction, without creating unnecessary turbulence that destroys the accuracy of separation. Floats exit the separator at the top side of one end of the separator and sinks exit the separator at the bottom of an opposite end of the separator.

Dense medium separation generally refers to a quiescent bath wherein the density of water, or some other medium, is changed by means of fine particles in suspension. The separation concept: one fraction floats, while the other fraction sinks, is relatively straightforward. However, this straightforward approach is lost when the task is to process a relatively large tonnage or volume of solids with accuracy.

As used hereinafter, the term “medium” or “suspension medium” refers to the liquid that forms a bath in which solids are introduced for separating. The density of the liquid medium can be adjusted by suspending varying amounts and types of fine particles in the medium. Also, the medium need not always be a liquid, but might instead be comprised of fine particles itself. As understood in the prior art, the function of the suspension medium in a separator is to induce vertical separation of solids based on the density of the solids. This is achieved by adjusting the density of the medium to a level between the lower density of the fraction of solids that are expected to float and the higher density of the remaining fraction of solids that are expected to sink. The term “sinks” refers to the solids that are expected to sink and the term “floats” refers to the fraction of solids that are expected to float in the medium. As a practical matter, dense medium separation can be an extremely efficient mechanism for separating bad produce, i.e., tainted, rotten or bad, from good produce. Typically, when produce turns (or begins the decomposition process), or it has been damaged or bruised, its density can also be effected. By measuring the densities of “good” and “bad” produce, an optimal density for a medium can be selected for efficiently separating the good from the bad. It should further be appreciated that the present invention will be described with regard to certain exemplary embodiments for separating specific types of solids using specific types of medium. These embodiments are selected for clarifying the description of the present invention and are not intended to limit the scope of the present invention in any way.

Several problems should be understood in order to achieve and maintain maximum efficiency in the separation process. The first of which involves the medium; it is sometimes difficult to assure stability and uniformity in the medium. Next are problems associated with the solids in separators designed for processing large tonnage or volume rates. The aim here is to separate out a relatively low amount of floats from a much larger amount of solids, hence the first problem is not burying floats with the much larger volume of sinks being introduced into the bath. Obviously, the reverse can also be problematic in cases where a larger volume of floats are introduced into the bath, e.g., these may tend to buoy the sinks. Even when the fraction of the floats is relatively low, as compared to the fraction of sinks, some sinks may report with the floats. Assuming that the sinks are the desirable form of the solid to be separated out, sinks that report with floats represent lost profits for the operator.

The problems mentioned above can be distilled into what the applicant considers to be the four first principles of a good dense medium separation.

1. A Stable and Uniform Medium

2. Correct Injection

3. A Correct Floats Dynamic

4. A Correct Sinks Dynamic

Without a stable and uniform medium throughout the bath, separation is not possible. At densities below 1.05 g/cc (gram per cubic centimeter (or also g/cm³ (grams per centimeters)) certain types of clay may be used to change the density of the water. Since the grain size of clay is small, generally below five microns, stability is not an issue, and provided the density remains below 1.05 g/cc, the medium does not become viscous.

Between 1.05 g/cc and 1.60 g/cc, fine sand between 10 and 50 microns may be used to create a suspension medium. Applicant has pioneered the use of fine sand in the separation of a variety of root vegetables as well as in the recycling of automobile, industrial and municipal waste. All root vegetables are grown in soils containing a certain percentage of fine sand, and in the shredding of waste materials, a fine “sand” consisting of glass and metals is generated in abundance.

By means of two stages of classifying cyclones, with the first stage separating at 50 microns and with the second stage separating at 10 microns, it is possible to obtain free-of-charge suspension fines that, when mixed with water, give all of the characteristics of the finest Newtonian suspension liquid. To prevent the accumulation of low-density fine organics, a certain percentage of the medium must be continually routed to filtering devices such as sieve bends, roto-sieves or rotary trommels. When dense medium separations above 1.6 g/cc are required, magnetite or ferrosilicon should be used. When dense medium separations below 1.0 g/cc are required, alcohols or oils may be used.

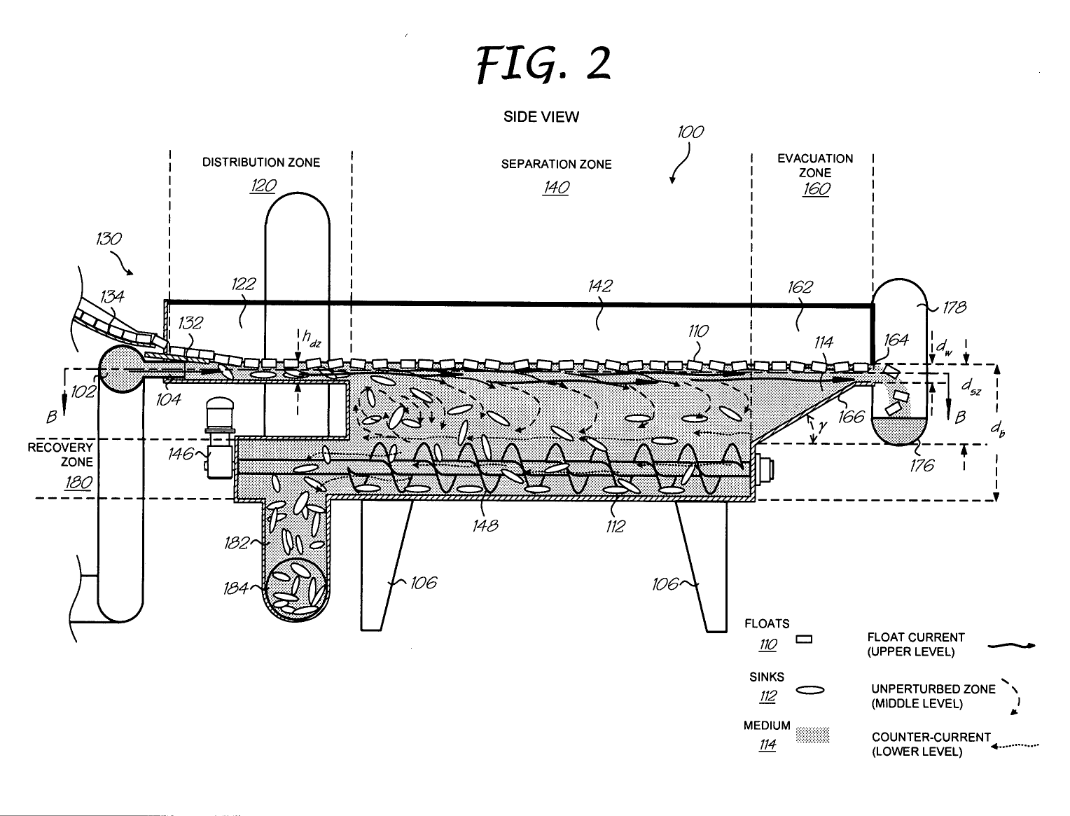

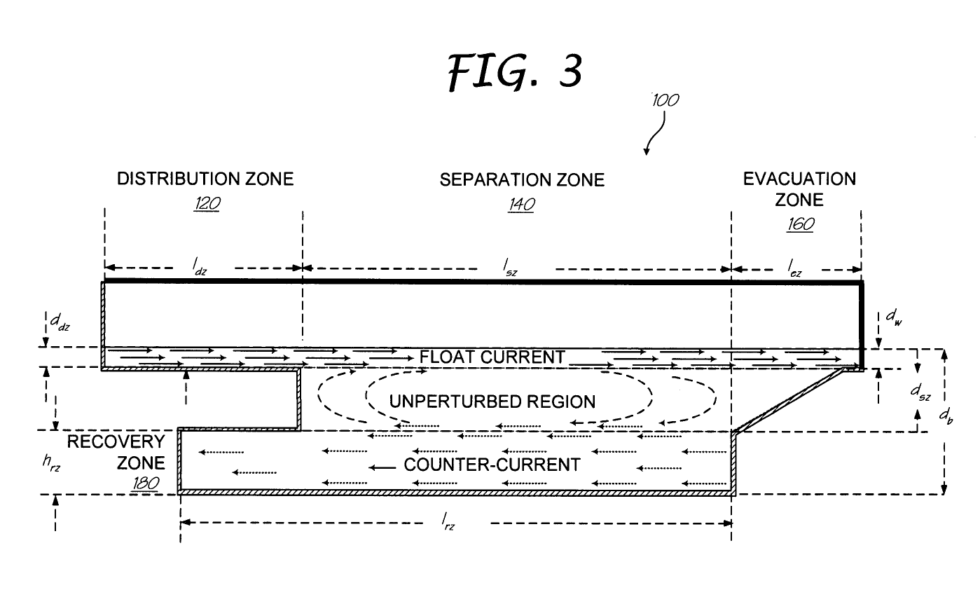

It is not enough to have a medium free of coarse suspension fines, fine clay or fine organics. The bath in which this medium is situated should not be too deep. In a dense medium separator, ideally the particles in suspension are only marginally stable, and in the case of a deep bath, these particles easily drop out of suspension, leaving water at the top of the bath and a thick sludge at the bottom of the bath. Of course, in such a stratified liquid, no separation takes place. For this reason, and in accordance with one exemplary embodiment of the present invention, for many applications, the bath depth throughout the entire separation zone should be no greater than about 500 mm or about 20 inches (see separation zone depth, d_{sz}, of separation zone 140 depicted in FIG. 2 and 3), although d_{sz} may increased for difficult separations operations. It should be mentioned that there is no absolute minimum or maximum depth for the separation zone. The objective is to provide as much depth in the separation zone as possible to facilitate the separation process, but not so deep as to induce the medium to become unstable.

However, adjusting the depth of the separation zone may not be enough to assure the stability of the medium. As the medium in the bath flows in the direction of its point of overflow, and in the direction of the weir, there exists a gentle counter-current movement generated by the action of a sinks device moving in the opposite direction, such as the action of scrolls, augers or belts pulling in the opposite direction and away from the weir. With medium carrying floats in one direction and with a sinks mover pulling sinks in the opposite direction, the proper amount of uniform turbulence is generated to assure the stability of the medium. This is referred to hereinafter, with regard to the presently described dense medium separator, as bi-directional flow. Furthermore, this bi-directional flow paradigm has the added benefit of inducing an elliptical circulation pattern in the medium.

With a stable and uniform medium throughout the bath, the solids should be introduced into the bath in a manner that does not induce the unwanted burying of floats with sinks. In accordance with exemplary embodiments of the present invention, the solids are uniformly introduced over the entire width of the bath, and if the material is sufficiently granular, optimally, the solid should be gradually metered into the bath by means of a vibrating screen or tray.

The solids then fall into the distribution zone of the separator. The distribution zone may be flat, inclined or concave. This distribution zone has roughly the same depth as the weir or overflow height at the opposite end of the bath. It should be recognized that in many applications the surface height varies across the length of the separator; higher at the distribution zone and lower at the evacuation zone where the medium exits the separator. Since there is very little depth to the bath at this point in the separator, the solids are laid out on a broad two-dimensional plane before being presented to the three dimensional space of the separation zone. Several injection scenarios are viable, for instance a series of injection nozzles situated along the entire width of the bath propel the solids from the distribution zone into the separation zone. In this way, at the critical moment of introducing solids into the bath, no floats are buried with sinks. Alternatively, the distribution zone may contain an overflow box for distributing the medium evenly across the width of the separation zone.

When the solids to be separated are relatively small in size, they can be mixed with medium and injected through the same nozzles mentioned above. In this way, they are introduced slightly below the operating level of the medium in the bath and cannot skim along the surface of the bath or be unduly influenced by the surface tension of the medium.

To obtain an accurate separation, there should be sufficient residence time for solids to float or sink. Therefore, the separation zone must be long enough to give a residence time in the separation zone that is sufficient for separation to occur, in many cases, at least 10 seconds. For very difficult separations, for instance those involving solids of a small grain size or solids with a large percentage of near-gravity material, this separation zone must be extended.

The speed of the medium flowing across the separation zone must match the surface density of the float solids. The term “surface density” is used herein to describe the weight of the solids laid out as densely as possible on a given surface without stacking one solid on top of the other. Typically, this would be measured in terms of kilograms/square meter or pounds/square foot. For example, the surface density of sugar beets might situate at 50 kgs/m², potatoes at 33 kgs/m² and sugarcane billets and carrots at 12.5 kgs/m².

If float solids do not exit the separator as fast as they enter, then they will accumulate in many layers on the surface of the separator, and eventually they can completely fill up the separation zone. So the medium flowing along the surface of the separator must move at a speed fast enough to evacuate the float solids of a specific surface density, and at the same time, the flow of medium must create sufficient space for sinks to sink and not be hindered or disturbed in their settling by the presence of floats and for the lighter density floats to float and not be hindered or disturbed in their floating by the presence of higher density sinks.

The height at which the medium overflows the bath (the weir height, or just weir) must be great enough to overflow the largest float solids. Typically, the weir height must be at least two thirds the diameter of the largest float solid to assure that this solid is propelled over the weir and out of the bath.

After the floats exit the separator, they then report to a vibrating screen, a rotary screen, a dewatering belt, or to any other appropriate device where they are dewatered and rinsed of any adhering medium. The medium that passes this dewatering device may be sieved to remove any fine organics that might contaminate it. The rinse water is then routed to cyclones or magnetic drums to recover the suspension fines.

As will be discussed elsewhere below, according to the exemplary embodiment of the present invention, there is no lifting of sinks within the separation zone. Lifting introduces far too much turbulence and easily destroys the accuracy of separation. Therefore, the sinks are moved completely out of the separation zone before they are lifted out of the bath. The sinks are moved horizontally along the bottom of the bath by a sinks mover, such as augers, belts or scraper chains, and only when they are completely outside the separation zone are they lifted up and out of the bath. The sinks can be lifted up and out of the bath by means of belts, augers, pumps, scraper chains and so forth. As will be discussed further below, the later device that lifts the sinks out of the bath is usually, but not always, independent from the former sinks mover.

After the sinks have exited the separator, they may then report to a vibrating screen, a rotary screen, a dewatering belt or to any other appropriate device where they are dewatered and rinsed of any adhering medium. This rinse water may be routed to cyclones or magnetic drums to recover the suspension fines.

The presently described invention is directed to a novel approach to dense medium separators that fulfills all of the first principles of a good dense medium separation. Since this separator operates on a predominantly horizontal plane, a large number of separators can be set up in a cascading series of separators, while occupying very little space.

One advantage of such a concept, of course, lies in the accuracy of separation. Here separations take place with an accuracy seldom found in the domain of dense medium separation. In terms of relative density, separations take place to within two to three points to the third decimal place. A few examples illustrate clearly the power of this technology.

For example, a good carrot of a density of 1.050 can be easily separated from a partially dehydrated carrot of a density of 1.053. A bad sugar beet of a density of 0.997 can be easily separated from a good sugar beet of a density of 1.002. A potato with a high solids content can be easily separated from a potato with a low solids content. Bad or diseased potatoes of a density below 1.04 can be eliminated from a potato canning line. Plastics of a density of 1.02 can be easily separated from plastics of a 1.04 density. Through the use of alcohols or oils to lower the density of water, it is even possible to separate plastics of densities less than 1.0.

In accordance with the forgoing, the present invention is directed to a dense medium separator for accurately separating solids by density. As will be described hereinafter, the present separator achieves separation accuracies that have heretofore not been achieved in prior art separators by establishing a pair of opposing currents for moving solids with different densities in opposite directions in the bath. To that end, a float current is established in a separation zone for transporting lower density solids (floats) by injecting medium at a first flow direction (the float's direction) and toward an evacuation zone with an overflow weir. The float current is maintained in an upper vertical level of the separation volume in the separation zone. Also provided is a sinks moving device at the lower vertical level, i.e., the bottom of the quiescent bath, for mechanically moving higher density solids (sinks) that have fallen out of the float current and to the bottom of the bath. These higher density solids are moved along the bottom of the bath and away from the separation area of the quiescent bath to a sinks recovery zone. Optimally, the sinks mover will not merely move higher density solids mechanically, but it will also establish a reverse or counter-current within and above the sinks mover. The counter-current is in the opposite direction of the float current, which aids in moving the higher density solids to the recovery zone, but also circulates the medium in the bath.

The bi-directional flow paradigm of the present separator substantially reduces the amount and severity of turbulence and disruptive eddy currents in the medium bath that hinder the separation process and reduce the separation efficiencies. However, even greater separation accuracies, resulting in much higher separation efficiency, are achieved by establishing a vertical interval of unperturbed medium in the separation zone (the unperturbed region) of the bath between the float current in the upper strata of the bath and the counter-current in the lower strata of the bath (and the sinks mover). The medium in the unperturbed region of the quiescent bath circulates gently in an elliptical path, in the direction of the float current near the top of the unperturbed region and in the direction of the counter current near the bottom of the unperturbed region, with upward and downward flows at the respective distribution and evacuation zone ends of the bath. Lifting the higher density solids across the unperturbed region of the bath and out of the separator, as is known in prior art separators, would perturb the medium in the vertical interval and create turbulence that would reduce the accuracy of the separation. Therefore, the higher density solids (the sinks) are allowed to sink out of the separation zone and into or past the counter-current formed by the sinks mover. Only then are the sinks moved horizontally on the bottom of the separator by the sinks mover, from underneath the separation zone and from under the separation zone before they are lifted out of the separator. The lifting operation takes place in a location that is remote from the separation zone and is performed by a lifting device (the sinks recovery device) that is remotely located from the sinks mover and usually independent from it.

Here it should be pointed out that the solids in suspension are only marginally stable and somewhat prone to dropping out of suspension. The result can be a lower density liquid at the top of the bath and a thick sludge at the bottom. Obviously, it is impossible to separate solids by their density if the density of the medium in the bath is not homogeneous throughout. The medium should, therefore, be agitated and/or recirculated through the system from time to time to keep the fine particles in suspension. This is true even for the medium in the unperturbed region of the bath. However, in contrast with prior art separators, the medium in the unperturbed region circulates about the region which tends to agitate and stabilize the medium. As mentioned directly above, the medium in the unperturbed region moves about the region in a generally elliptical path; in the direction of the flow current near the top of the unperturbed region and in the direction of the counter-current near the bottom of the unperturbed region, with an upward flow near the distribution end and a downward directional flow at the overflow end.

This upward and downward movement of the medium at the two extremities of the ellipse is beneficial to the separation process of the present invention. Any sink solids, that have not fully sunken but situate on the float side of the ellipse, are gently coaxed downward, and any float solids that have not fully surfaced yet situate on the sink side of ellipse, are gently coaxed upward. However, a float solid that has fully surfaced and situates on the float side of the ellipse has little chance of being caught in the downward movement of medium at the float side of the ellipse, because the overflow of medium at the surface of the bath on the float side of the ellipse is far more powerful than the downward flow of medium at the float side of the ellipse. Likewise a sink solid that has fully sunken and lies at the sink side of the ellipse has little chance of being caught in the upward flow of medium at the sink side of the ellipse, because the movement of the mechanical device at the very bottom of the bath is far more powerful than the upward movement of medium at the sink side of the ellipse.

The elliptical circulation also generates a uniform turbulence in the unperturbed region to assure the stability of the medium contained therein. Nevertheless, regardless of the beneficial effects of the elliptical circulation, the medium in the unperturbed region should also be regenerated from time to time to further control their true density and filter out any low-density fine organics.

The primary force driving the solids in the unperturbed region of the separator is the separation density, i.e., the difference between the density of a solid and the medium. The lower density solids (floats) separate upward, into the float current where they are extracted at the extraction zone, while the higher density solids (sinks) separate downward, into the counter-current and on to the sinks mover, where they are recovered in the recovery zone. Because there is virtually no turbulence, eddy currents, vortexes or perturbations in the unperturbed region of the bath, the density separation is highly accurate and efficient in that region.

The exemplary embodiments described below were selected and described in order to best explain the principles of the invention and the practical application, and to enable others of ordinary skill in the art to understand the invention for various embodiments with various modifications as are suited to the particular use contemplated. The particular embodiments described below are in no way intended to limit the scope of the present invention as it may be practiced in a variety of variations and environments without departing from the scope and intent of the invention. Thus, the present invention is not intended to be limited to the embodiments shown, but is to be accorded the widest scope consistent with the principles and features described herein.

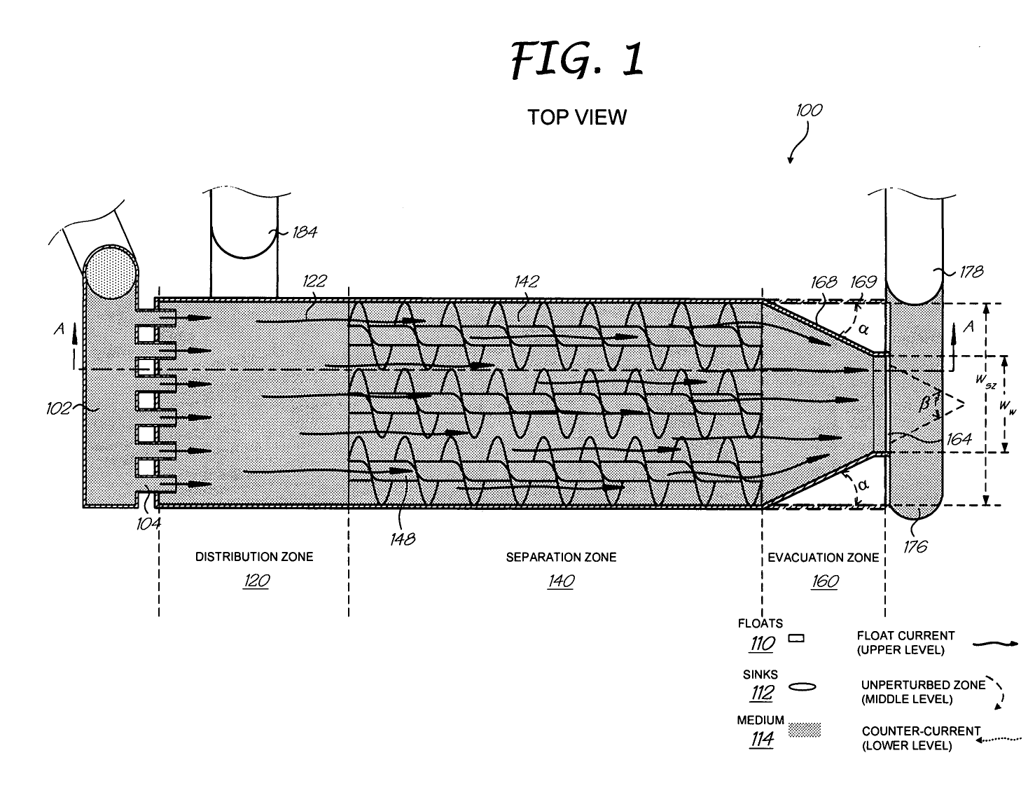

FIGS. 1 and 2 depict dense medium separator for separating solids by specific gravity. FIG. 1 is a cross-sectional top view of the exemplary dense medium separator shown in FIG. 2 at section lines BB, and FIG. 2 is a cross-sectional side view of the separator shown in FIG.1 from section lines M. FIG. 3 a cross-sectional side view that depicts the individual zones of the presently described separator. Shaded areas indicate the presence of the suspension medium in the quiescent bath and the arrows indicate the direction of the solids in the medium; solid lines are indicative of the first flow direction of the medium from the injectors (the float current) which drives the lower density solids (referred to hereinafter as the “floats”), spotted lines are indicative of a second flow direction of the medium (the sink current or counter-current) which facilitates movement of the higher density solids (referred to hereinafter as the “sinks”) in a direction substantially opposite to the float current, and the dashed lines are indicative of the movement of the generally elliptical path of the medium in the unperturbed region of the bath. Although it is customary in the relevant technological arts to refer to the things being separated as either “particles” or “solids,” the term solid will be used hereinafter.

In accordance with one exemplary embodiment of the present invention, dense medium separator 100 establishes a float current in a suspension medium bath in a first direction toward a weir which moves a float fraction of the solids toward an evacuation zone and, simultaneously, moves a sinks fraction of the solids horizontally along the bottom of the bath in a substantially opposite direction to the float current toward a recovery zone. The mechanism which moves the sinks across the separator also creates a counter-current that flows approximately opposite to the float current. The float current is formed and maintained in an upper stratum of the quiescent bath, the counter-current is formed and maintained in a lower stratum of the bath and the unperturbed, non-turbulent volume is established between the upper and lower vertical levels of the bath. The upper and lower strata are not coincident, but instead are separated by a region of a relatively unperturbed but stable medium. The float current and counter-current, on the upper and lower extents of the unperturbed region, interact with the medium in the unperturbed region to induce a gentle elliptical flow within the unperturbed region. The elliptical circulation increases the efficiency of the separation process by facilitating the movement of submerged solids in a direction that is consistent with their respective densities, while simultaneously generating a uniform turbulence in the unperturbed region that assures the stability of the medium in the region.

As can be appreciated from FIGS. 1, 2 and 3, dense medium separator 100 generally comprises four independent and separate zones: distribution zone 120; separation zone 140; evacuation zone 160; and recovery zone 180 Before describing the individual components that are disposed within the individual zones of dense medium separator 100 (referred to hereinafter merely as a separator, for brevity), attention is directed to FIG. 3 which depicts the general geometry and dimensions of the separator. Here it should be appreciated that the dimensions described herein are not absolute but are relative to the mission or application of the type of separation process being performed by a particular separator. Distribution zone 120 is defined by distribution volume 122 of distribution zone length×distribution zone depth×separator width (l_{dz}×d_{dz},×wₛ). Distribution zone 120 is located on one extent of the quiescent bath.

For very difficult separations, for instance those involving solids of a small grain size or solids with a large percentage of near-gravity material, this separation zone must be extended. Separation zone 140 is situated between distribution zone 120 and evacuation zone 160 and above recovery zone 180, hence the separator bath depth, b_{d}, is deeper than d_{sz} by the height of recovery zone 180, h_{rz} (b_{d}=d_{sz}+h_{rz}). Separation zone 140 is significantly deeper and longer than distribution zone 120. A useful approximation for the depth of separation zone 140 is five times that of the depth of distribution zone 120. The absolute depth of separation zone 140 and the precise relationship to the depth of distribution zone 120 will depend on the application of the particular separator. The length of separation zone 140, l_{sz}, is at least partially dependent on the residence time necessary for separation, and therefore also depends on the particular application of the separator. Separation volume 122 is shown as separator zone length×separator zone depth×separator width (×d_{sz},×wₛ). Separation zone 140 should be long enough such that the sinks have a sufficient time to sink below the float current and enter the unperturbed region before the solids are moved across separation zone 140 and forced over weir 164. The minimal time necessary to achieve separation is referred to as the “residence time” of the separation zone 140. Therefore, in accordance with one exemplary embodiment of the present invention, the length of separation zone 140, l_{sz}, is dependent on achieving a particular residence time in the separation zone for a particular type of separation to occur. For very difficult separations, for instance, separations involving solids having a small grain size or solids that are very close in density to the density of the medium, l_{sz}, could be increased to allow for a greater residence time (alternatively, weir (overflow) depth d_{w} may be decreased to achieve more residence time). The length of separation zone 140, l_{sz}, is at least partially dependent on the residence time necessary for separation, and therefore also depends on the particular application of the separator.

Evacuation zone 160 is on the opposite side of separation zone 140 from distribution zone 120 and in certain instances may have a triangular cross-sectional shape that is defined by its vertical interface with separation zone 140, the surface of the bath and tapered evacuation bottom 166 that is upturned from the bottom of separation zone 140 toward weir 164. Evacuation zone 160 has a maximum depth of d_{sz}, adjacent separation zone 140, and a minimum depth of d_{w} at weir 164. The weir depth, d_{w}, is based on the geometry of the solid being separated. As a general rule, d_{w} is approximately two-thirds the average height of the float solids exiting the separator at weir 164. As used hereinafter, the term “weir” refers to the vertical depth or overflow height of medium 114 above the uppermost edge of tapered evacuation bottom 166 (in some instances the term “weir” is used to refer to a structure that the medium overflows, such as an overflow-type dam). Additionally, the sides of evacuation zone 160 in certain instances may be configured to form a trough at the overflow weir in order to restrict the amount of flow directed to weir 164, from a maximum width of w_{sz} to a minimum width of w_{w}.

Recovery zone 180 extends the entire length of separation zone 140 and continues at least partially beneath distribution zone 120, i.e., l_{rz}>l_{sz}, however recovery zone 180 is not in direct hydraulic contact with distribution zone 120. The added length provides spatially isolation to the unperturbed region from the lifting mechanism. Since sinks 112 are lifted out of the bath at a remote area from the unperturbed region, the unperturbed region is isolated from the subsurface turbulence, eddies and vortexes that are typically associated with lifting sink solids out of the bath; separation accuracy increases dramatically. Recovery zone 180 does not extend beneath evacuation zone 160. The height of recovery zone 180 is shown in the figure as height h_{rz}, which is separate and not included in d_{sz}, hence the total depth of the medium bath, d_{b}, may be understood as d_{b}=h_{rz}+d_{sz}.

Each of the zones in separator 100 has a different purpose, but the zones cooperate together to facilitate the separation of solids by their specific gravity in a manner heretofore not realized by the prior art. The function of distribution zone 120 is to distribute medium 114 and solids in the bath at an optimal rate and manner for accurate separation to occur. Medium 114 is injected evenly along width wₛ distribution zone 120 at an optimal velocity for the type of separation. The solids are introduced into the flowing medium at a rate that is consistent with the flow rate. Fresh solids are distributed evenly along width wₛ of distribution zone 120 in a single, even layer, as space in the bath becomes available as the previous solids are driven away from distribution zone 120.

The function of separation zone 140, on the other hand, is to provide a volume of medium 114 that is long and deep enough for the fraction of sinks to separate from the solids. The depth of the separation zone, d_{sz}, should be sufficient for establishing a counter-current under and in the opposite direction of a float current, and for establishing an unperturbed region of between the float current and counter-current in which an elliptical circulation is induced. Some movement in the unperturbed region is necessary to prevent the fine particles in suspension of the medium from falling out and thereby altering its density (i.e., the gentle elliptical circulation). Because, in many instances, the difference in density between the floats and sinks is relatively small, the higher density sinks can be lifted into the float current by subsurface turbulence, eddies and vortexes. Conversely, lower density floats can be sucked under the float current by the same type of turbulence and into the path of the sinks. Thus, and in accordance with one exemplary embodiment of the present invention, the depth of separation zone 140, d_{sz}, of separator 100 comprises two distinct vertical strata; a upper stratum containing a float current of medium flow in a first direction; and a separate lower stratum containing a counter-current of medium flow in a direction substantially opposite to the first direction. d_{sz} of separation zone 140 is also sufficient for establishing a quiescent interval (the unperturbed region) between the upper and lower strata in which a gentle elliptical medium circulation is induced. The primary force influencing the movement of solid in that quiescent interval is the disparity in densities of the submerged solids and that of the medium.

The function of evacuation zone 160 and recovery zone 180 are essentially identical, i.e., to evacuate/recover the solids from the medium bath, but the two accomplish their function in slightly different ways. Additionally, evacuation zone 160 and recovery zone 180 both separate the solids from the medium (dewater the solids) and recover medium 114 for recirculating back into the bath. Since the lower density solids, floats 110 are moved across the surface of separation zone 140 and into evacuation zone 160 by the float current, floats 110 are evacuated across weir 164 and out of the separator. By contrast, higher density solids, sinks 112, fall to the bottom of separation zone 140; once there the sinks are moved horizontally along the bottom of separation zone 140, in a direction counter to the float current and into recovery zone 180. Sinks 112 are recovered in sinks recovery hopper 182 and lifted out of the separator.

As alluded to above, the purpose of a separator is often to separate “good” product from “bad” product. For example, typically the density of organic solids changes, or decreases, as they spoil. In those situations, separator 100 is configured to recovery a good product that sinks. There, the aim is to separate the good product that will sink, and then recover it in recovery zone 180, from the spoiled product that will float in the medium and is evacuated from the surface of the bath in evacuation zone 160. By contrast, in other cases, bad product may dehydrate and be denser than the good product. In still other situations, contaminates may be separated from product by density. For instance, stones, rocks and sand can be separated from root vegetables by density. In either of the latter two cases, the rocks, stones, sand and dehydrated product is denser than the good product. The good product, the root vegetables etc, will float and be evacuated from the bath in evacuation zone 160. The bad product or contaminants will sink and be recovered in recovery zone 180. The same principle is possible with certain types of minerals, such as coal. There, the relatively lower density anthracite, bituminous and lignite forms of coal can be separated from the higher density shales mixed with the coal by the recovery/excavation processes.

With further reference to FIGS. 1 and 2, separator 100 generally comprises a distribution device 130 within distribution zone 120 for evenly distributing solids and medium across distribution volume 122 of the quiescent bath. As mentioned above, the purpose of distribution zone 120 is two-fold: to inject medium 114 across the width of the distribution zone with as little turbulence as possible, i.e., in an essentially laminar flow; and to simultaneously distribute the solids across distribution zone 120, in a likewise even manner. In accordance with one exemplary embodiment of the present invention, medium is injected in a direction oriented substantially toward weir 164 at the evacuation end of separator 100, i.e., evacuation zone 160. This injection stream forms a float current in which the solids are introduced, usually dropped, that are then driven by the force of the float current toward weir 164. Recall that at this stage the solids have not yet separated into their component fractions of floats and sinks.

Optimally, the float current is confined to only the upper stratum of the quiescent bath. Confining the float current to the uppermost vertical layer of separation zone 140 can be realized by several means. First, injector nozzles 104 are mounted parallel to one another in a horizontal plane within the upper stratum and in the direction of the evacuation zone. Also, the geometric shape of distribution volume 122 inhibits the float current from diffusing outside the upper stratum of separation zone 140. By defining distribution zone 120 with a shallow draft and being relatively long, the float current exits distribution zone 120 in a stable laminar flow state that resists dispersing into the lower strata of the bath. Additionally, by keeping the depth of distribution zone, d_{dz}, approximately the same depth as weir 164 (i.e., weir depth d_{w}, (d_{dz}≈d_{w})), the medium being drawn over the weir siphons medium from the bath at approximately the same depth as the distribution zone and within the upper stratum of the float current. It should be appreciated, however, that under certain conditions the bath level is slightly higher at distribution zone 130 than at weir 164 of evacuation zone 160, as a result the surface of the bath may have a slight downhill slope toward the weir.

With further regard to distribution zone 120, since the depth of distribution zone 120 is approximately equal the depth of weir 164, (d_{dz}≈d_{w}) then in some situations the depth of the distribution zone can be determined by the size of the solids being separated. Optimally, d_{w} should exceed the height of the upper edge of tapered evacuation bottom 166 by approximately two-thirds the average height of floats 110 to ensure that all of floats 110 will overflow the weir at evacuation zone 160. Therefore, for those situations the depth of distribution zone 120, d_{dz}, will also be approximately two-thirds the height of floats 110. The solids being separated will not always possess a uniform size or shape; some have ovular, oblong or irregular shapes. When immersed in medium 114, float solids will typically orient themselves with their major axis (the widest cross-sectional plane) at an approximately horizontal attitude, or parallel with the surface of the quiescent bath. The minor axis (the narrow cross-sectional dimension perpendicular to the major axis) will rotate into a vertical orientation. For other separations, for instance those involving solids of a small grain size, the depth of distribution zone 120 may be somewhat deeper than the weir depth, (d_{dz}>d_{w}).

More particularly, distribution device 130 generally comprises separate medium distribution components and solids distribution components for achieving the functionality described above. The medium distribution components of this exemplary embodiment generally comprise a mechanism for pumping medium 114 into distribution zone 120 from injection pipe 102 by, for example, a plurality of injection nozzles 104. Injection nozzles 104 are evenly dispersed along the lateral extent of distribution zone 120 and are aimed in the direction of evacuation zone 160. The solids distribution components generally comprise a conveyer or other mechanism for transporting the solids to a device for distributing the solids into the medium bath, such as distribution slide 134 and vibration table 132. As depicted in the figure, solids slide from a transport to slide 134 and onto optional vibration table 132 which vibrates the solids toward an open end and into the bath. The vibration has the effect of tamping the solids into a single level along the full width of the table. Vibration table 132 prevents pile-ups in distribution zone 120 by vibrating the solids into a single layer over the table. Thus, as the solids fall into the bath of distribution zone 120, they effectively cover the entire lateral extent, or width wₛ, of distribution zone 120 in a single layer. Conversely, distribution device 130 may be configured in the reverse with vibration table 132 distributing solids evenly along slide 134 which redirects the solids into the bath (not shown).

As the solids enter the bath, the float current generated by injection nozzles 104 move the solids in the direction of evacuation zone 160 and away from vibration table 132, which, in turn, creates a void in the bath for the next solids from vibration table 132 to fall. The feed rate from vibration table 132 should be synchronized with the speed of the float current in order to reduce the incidence and severity of pile-ups, (as will be discussed below, the injection velocity of the medium is set by the minimum residence time necessary for solids to separate into sinks and floats in separation zone 140). If the solids pile-up, floats 110 can be covered up by sinks 112 resulting in the undesirable consequence of sinks 112 being evacuated with floats 110 at the evacuation zone 160. Conversely, sinks 112 can cover floats 110 resulting in another undesirable consequence, that of floats 110 being forced downward in the bath and being harvested with sinks 112 from recovery zone 180. In either case, the accuracy of the separation process suffers due to inefficiencies in the distribution zone.

Pile-ups are more prevalent when the injection rate from injection nozzles 104 is not constant. Nozzles tend to clog, which results in pile-ups and increases the turbulence in the float current. Furthermore, some smaller types of solids cannot be vibrated into the bath because they can be supported by the surface tension of the medium and even the sinks tend to ride over the surface to the weir. This condition can be resolved by premixing the solids in medium 114 prior to injecting. However, premixing the solids tends to increase the frequency of nozzle clogging. Therefore, in accordance with still another exemplary embodiment of the present invention, injection pipe 102 outfalls directly into distribution zone 120 (not shown). Typically, the outlet for injection pipe 102 is positioned proximate to the lower vertical extremity of distribution zone 120. Medium 114 fills the volume of the distribution zone 120 and across the entire lateral extent of the separator, as a continuous, laminar sheet of medium in the direction of evacuation zone 160. In accordance with yet another exemplary embodiment of the present invention, the outlet to injection pipe 102 is located behind a slide used for introducing the solids into the bath (not shown). The lowermost end of the slide may extend beneath the surface of the medium and function as a baffle to quell any turbulence in medium 114 created by injection pipe 102. Thus, the solids entering medium 114 from the slide do so in a turbulence-free float current.

In any case, after the solids leave distribution zone 120 they enter separation zone 140. As mentioned elsewhere above, the purpose of the separation zone of the present invention is to provide a volume for separation to occur. Within separation zone 140 is an unperturbed and turbulence-free volume of medium for separation to occur. A useful approximation for a sufficiently deep separation zone 140 is five times that of the depth of weir 164, but the absolute depth depends on the separation. In this configuration, the medium evacuating across weir 164 will draw medium from separation zone 140 at approximately the same vertical stratum as the medium entering separation zone 140 from distribution zone 120. Thus, the float current is injected into, drawn from, and traverses the upper vertical stratum across separation zone 140 without being diverted or channeled in any other direction. Consequently the float current is confined to a relatively shallow vertical stratum in separation zone 140 and does not induce turbulence into the unperturbed region of separation zone 140.

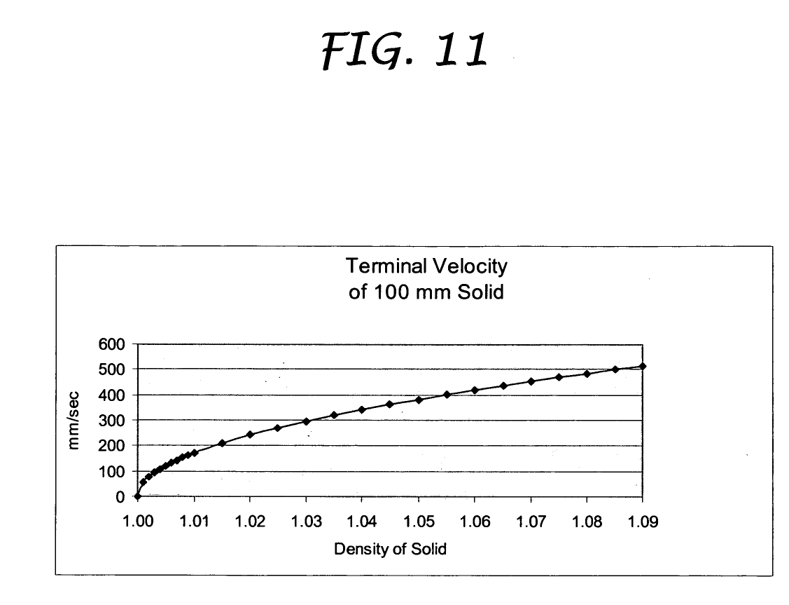

The separation zone should also be long enough for sinks to fall to the bottom of separation zone 140 in the time it takes for a float to traverse the extent of separation zone 140 (the residence time). Therefore, the length of separation zone 140 depends on the depth of the separation zone d_{sz}, the terminal velocity of the particular solid in suspension medium being employed, and the residency time for the particular solids (see FIG. 11 and Table VI for terminal velocity rates).

The volume of medium in separator 100 can be categorized as one of two distinct strata levels: an upper stratum, discussed above, which includes the float current flows in the direction of evacuation zone 160 and drives the floats and a lower stratum where the sinks move horizontally across the bottom, in the opposite direction of the float current. This lower stratum may also include a counter-current which gently flows in the opposite direction to the float current. Between the upper and lower strata, under the float current and above the counter-current, is a middle layer in which the medium is relatively unperturbed and turbulence-free (the unperturbed region). The medium in this unperturbed region is not motionless, but instead circulates in a gentle elliptical path. This elliptical movement is beneficial to the separation, by gently coaxing submerged solids in a direction consistent with their density, and it also generates a uniform turbulence to assure the stability of the medium in the region.

In general, the medium in the unperturbed region may exhibit a slight upward bias, with a greater volume of the medium exiting the unperturbed region upward into the evacuation zone than downward into the recovery zone. The upward flow component of the medium of the unperturbed region is very slight and therefore, will not impede the separation process. The medium in the unperturbed region is drawn into evacuation zone 180 where it can be recirculated. During recirculation, medium 114 collected at recovery zone 180 and evacuation zone 160 is piped to medium tank 208. Prior to medium 114 being pumped back to the separator, its suspension fines may be regenerated and filtered for contaminants.

In the unperturbed region, the disparity in the specific gravity of the solids and medium is the predominant drive force for moving the solids. The unperturbed region is free from any subsurface turbulence, eddies and vortexes that might inhibit separation. Solids that drift into the unperturbed region of separation zone 140 are accurately and efficiently separated into either the float current by the positive buoyancy or the counter-current by their negative buoyancy. As a result, floats 110 that are forced into the unperturbed region by some interaction in the upper float current have the opportunity to buoy back into the float current to be evacuated at evacuation zone 160 with other floats. Conversely, sinks 112 that enter the unperturbed region of separation zone 140 will sink into and past the counter-current where they are moved horizontally along the bottom of the unperturbed region into recovery zone 180.

With regard to evacuation zone 160, the evacuation zone is designed to efficiently evacuate both floats 110 and medium 114 from separator 100 without unnecessarily perturbing either the float current or the unperturbed region of medium in separation zone 140. This can be realized by overflowing the entire volume of the float current, with the floats, over weir 164. In so doing, disruptive reflections, currents, eddies, vortexes and/or perturbations generated by the float current reflecting off the weir, that might disrupt the unperturbed medium, are minimized.

Evacuation zone volume 162 is defined as a configurable volume bounded by evacuation sidewalls 169 and tapered evacuation bottom 166. Evacuation zone 160 has a generally triangular-shaped cross-sectional shape between separation zone 140 and tapered evacuation bottom 166 that shallows toward weir 164. The tapered shape of tapered evacuation bottom 166 compresses the vertical interval of float current upward, toward weir 164. Tapered evacuation bottom 166 channels a portion of the floats current toward weir 164 that would otherwise lodge in a vertical wall and disrupt the separation zone. This redirected upward flow, or upwelling float current, has the effect of lifting floats 110 over weir 164 and thereby, decreasing the instances of “log jams” at the upper edge of tapered evacuation bottom 166. The evacuation zone taper angle, γ, is typically less than 30 degrees, and its magnitude inversely proportional to the intensity of the float current, the faster the float current, the gentler the evacuation zone taper angle. The taper of the bottom in evacuation zone 160 does not disturb the elliptical circulation in the unperturbed region.

In some situations, however, the velocity of the float current might be too weak to ensure that all floats 110 are evacuated over weir 164. Therefore, and in accordance with yet another exemplary embodiment of the present invention, evacuation volume 162 may be configurable for increasing the velocity of medium 114 exiting the separator, for instance, into a generally trough shape. Ordinarily, evacuation sidewalls 169 of evacuation zone 160 are parallel with the sidewalls of the separation zone 140. Optionally however, evacuation sidewalls 169 can be reoriented into a generally trough configuration, shown in FIG. 1 as evacuation trough sidewall 168. This narrowing of the separator's width restricts the passageway across evacuation zone 160 and increases the velocity of the float current overflowing weir 164. Increasing the magnitude of evacuation narrowing angle, α, reduces the overflow width at weir 164. The evacuation trough angle, β, may vary from approximately 180 degrees (where evacuation trough sidewalls 168 are substantially parallel to each other and the weir width is approximately equal to the width of separator 100 (w_{w}≈wₛ)), to approximately 60 degrees, where the weir width w_{w} is much narrower than the separator width wₛ (w_{w}<<wₛ).

The float current forces floats 110 and medium 114 over tapered evacuation bottom 166 at weir 164 and into floats recovery trough 176. Floats recovery trough 176 catches floats 110 and medium 114 and then channels them to floats recovery device 178, which separates the floats from the medium (known as dewatering). Floats recovery device 178 may be any type of device for extracting solid floats 110 from the medium, such as a vibrating dewatering screen, a sieve bend or a rotary trommel screen. The medium is evacuated from the floats dewatering device to a tank and on to recirculation pump (not shown) connected to medium injection pipe 102.

Sinks 112, on the other hand, eventually fall to the bottom of separation zone 140. In stark contrast with prior art separators, sinks 112 are not lifted from the bottom of separation zone 140, but instead are moved horizontally along the bottom of separation zone 140 and away from the separation zone before they are lifted out of the bath. Lifting sinks 112 from the separation zone introduces turbulence and perturbs the medium in the separation zone. The turbulence induced by lifting decreases the accuracy of separation and lowers the efficiency of the separator. A sinks mover is disposed at the bottom of separation zone 140 that mechanically moves the sinks out of the separation zone and simultaneously creates a counter-current. The denser sinks that immediately fall to the bottom of separation zone 140 are engaged by mechanical sinks mover 148, such as screws, scrolls, belts, scrapers or as depicted in the figure, augers. Sinks 112 are then moved horizontally into sinks hopper 182, which is spatially isolated from separation zone 140. Mechanical power is provided to the sinks mover by one or more motors 146. In addition to dragging sinks 112 across the bottom of the separation zone, the action of the sinks mover creates a counter-current in the opposite direction of the upper float current that drives the sinks toward sinks recovery hopper 182 before they contact sinks mover 148. This counter-current moves slower sinking sinks (lower density sinks) in the direction of sinks recovery hopper 182 before sinks mover 148 engage them. Thus, the counter-current moves the more buoyant and slower falling sinks, those that have not reached the bottom of separation zone 140, toward sinks recovery hopper 182 without inducing turbulence in the unperturbed separation level.

The figures depict separator 100 as having three independently driven auger-type sinks movers aligned in a horizontal plane at the bottom of separation zone 140. However, the figure is not intended to limit the number, type or drive mechanism for the sinks mover of the present invention. For instance, separator 100 may employ one, two, four, five or any number of separate sinks movers at the bottom of the separations zone. These may be driven independently from each another, with separate drive motors, or may instead receive driving power from a common power take-off. Moreover, the figures generally depict sinks mover 148 as laying in a common horizontal plane, however, in other embodiments the auger may be fixed at different vertical levels in separation zone 140, such as positioning the outer augers higher than the inner augers, or vice versa. Furthermore, neither the presently described separator nor the presently described dense medium separation process is dependent on the type of sinks mover employed. Although sinks mover 148 are depicted as augers in the figures, these are merely illustrative of any sinks mover for moving higher density sinks along the bottom of separation zone 140 in the opposite direction of the float current driving the lower density floats, while simultaneously creating a counter-current that is also opposite to the float current. Other types of sinks movers can be employed without departing from the scope of the present invention. Virtually any device capable of moving the higher density sinks along the bottom of the bath could be substituted for the exemplary auger, for instance, belts, scraper chains, paddles or the like. Optimally, the sinks mover employed would also create a counter-current to facilitate movement of the sinks to the recovery zone, but this feature is in no way essential to the present invention. FIG. 3 depicts a cross-sectional side view of a dense medium separator that uses belt and paddle 149 rather than an auger to recover sinks on the bottom of separation zone 140 in accordance with another exemplary embodiment of the present invention. Notice that in accordance with this embodiment, belt and paddle 149 moves sinks 112 horizontally across the bottom of separation zone 140, while the paddles create a counter-current in the direction of the sinks movement. Furthermore, in some separators and for some separations the sink mover may not be mechanical, but may instead be a hydraulic mover.

Sinks 112 are moved horizontally along the bottom of separation zone 140 and into sinks recovery hopper 182. There, the sinks are removed, or lifted, from the separator 100 by recovery device 184, such as a lift, auger, belt scraper or other type of transport. Because recovery device 184 is located away from the unperturbed region of the separation zone 140, the lifting of sinks 112 will not create turbulence in the unperturbed region, as is common in prior art separators. Typically, recovery device 184 and sinks mover 148 are independently driven and powered. In so doing, one device may be operated at a higher rate than the other, for instance recovery device 184 lifting upward at a faster rate than sinks mover 148 moving horizontally. However, in other situations, recovery device 184 and sinks mover 148 may be mechanically coupled or even extension of the same device, such as a continuous belt. Recovery device 184 delivers the sinks to a dewatering device (not shown) such as a vibrating screen, rotary screen, dewatering belt or to any other appropriate device that dewaters and rinses the sinks of any adhering medium. The rinse water may then be routed to cyclones or magnetic drums to recover the suspension fines and reused in the medium.

The above described embodiments disclose a dense medium separator and methodology for separating solids by their respective densities by using a dense medium with separation accuracies higher than currently achievable by prior art separators. In so doing, the separation efficiencies are greatly increased. Furthermore, the design of the presently disclosed separator lends itself to cascading separation in which the output of one separator provides solids for a second separator and separation process and so on. However, other improvements and further optimizations are possible.

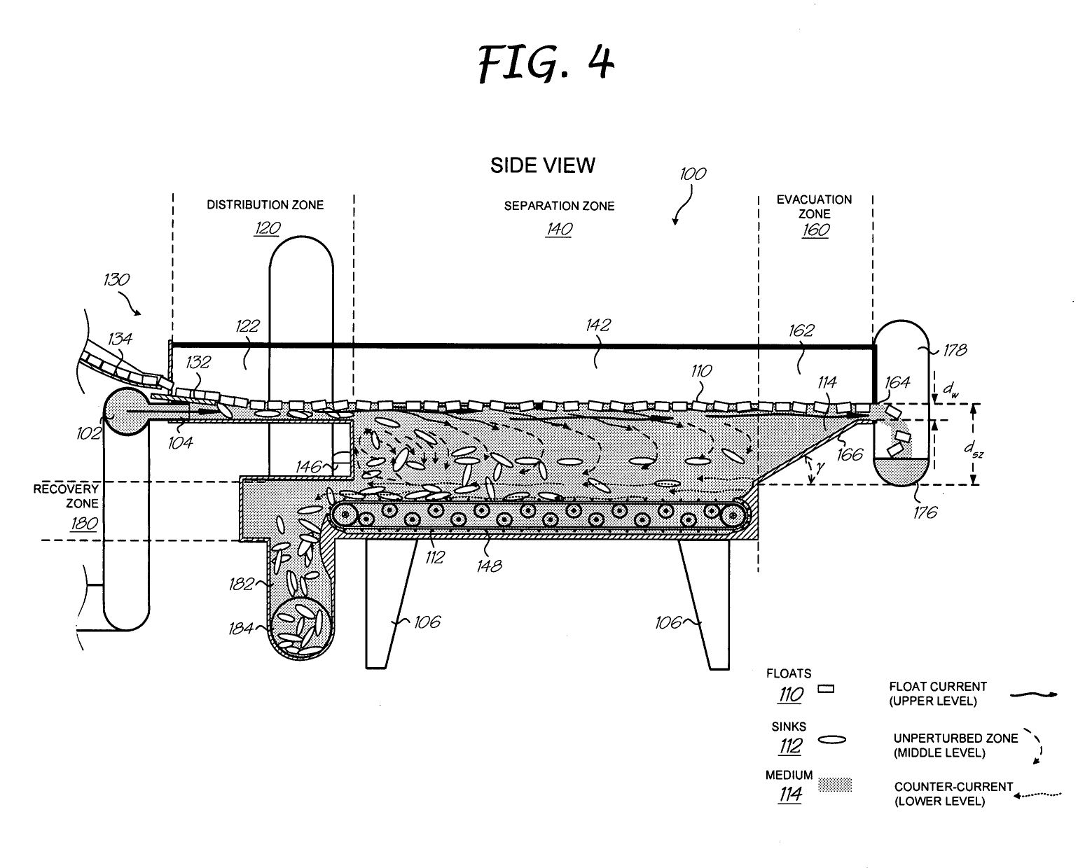

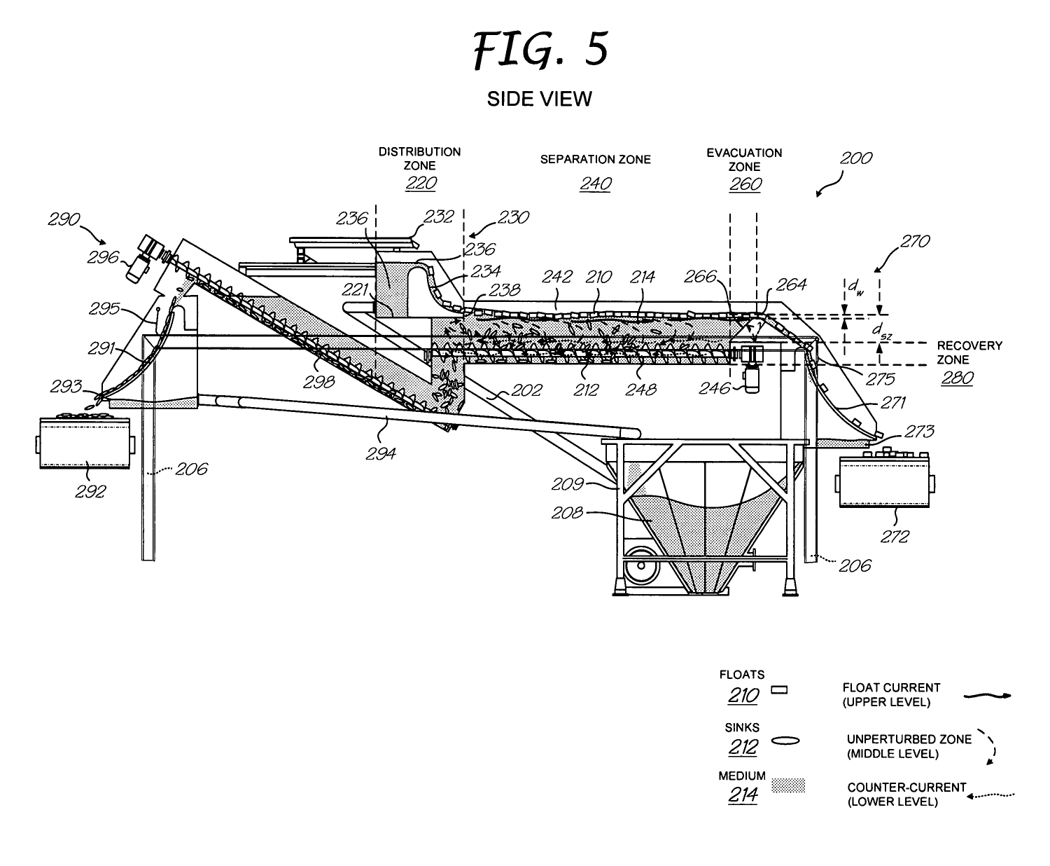

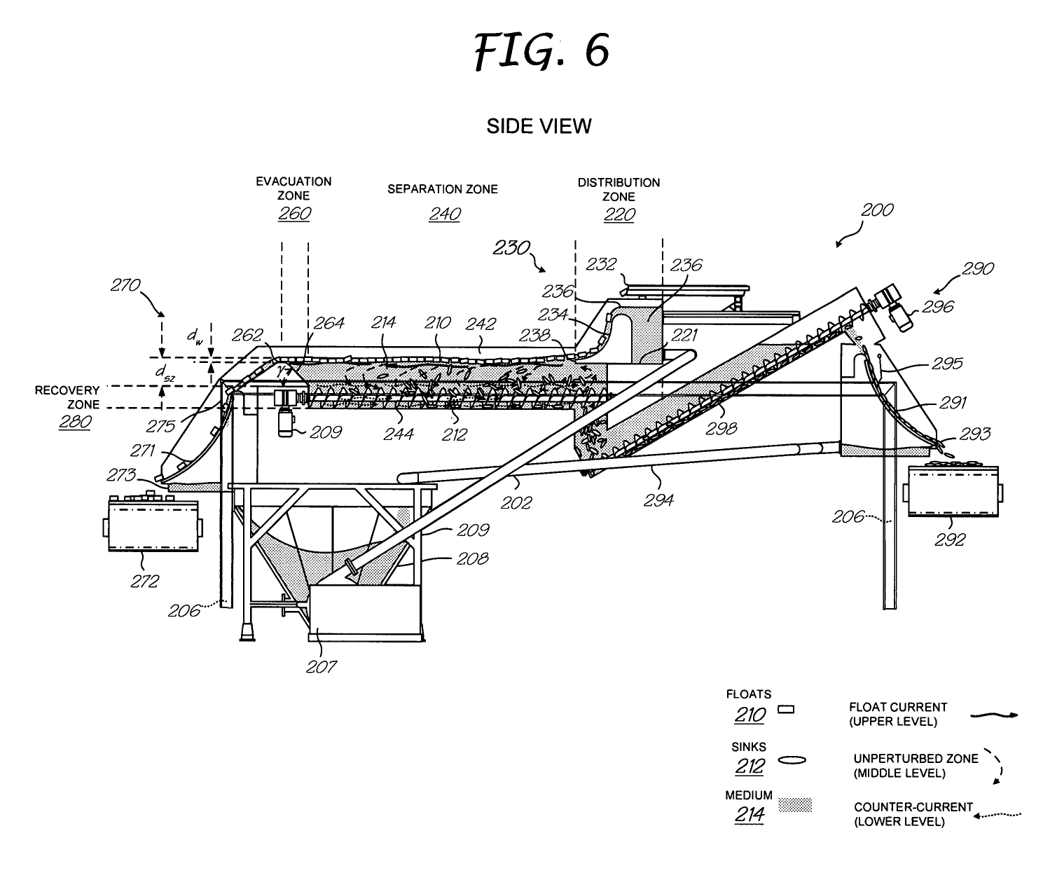

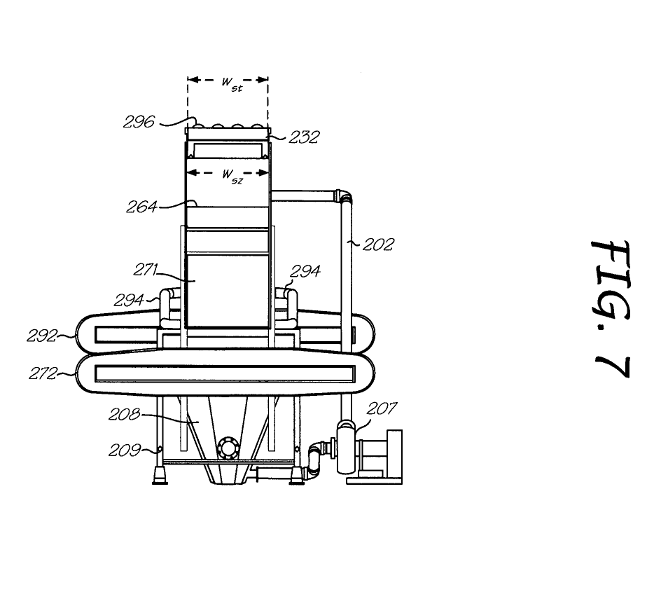

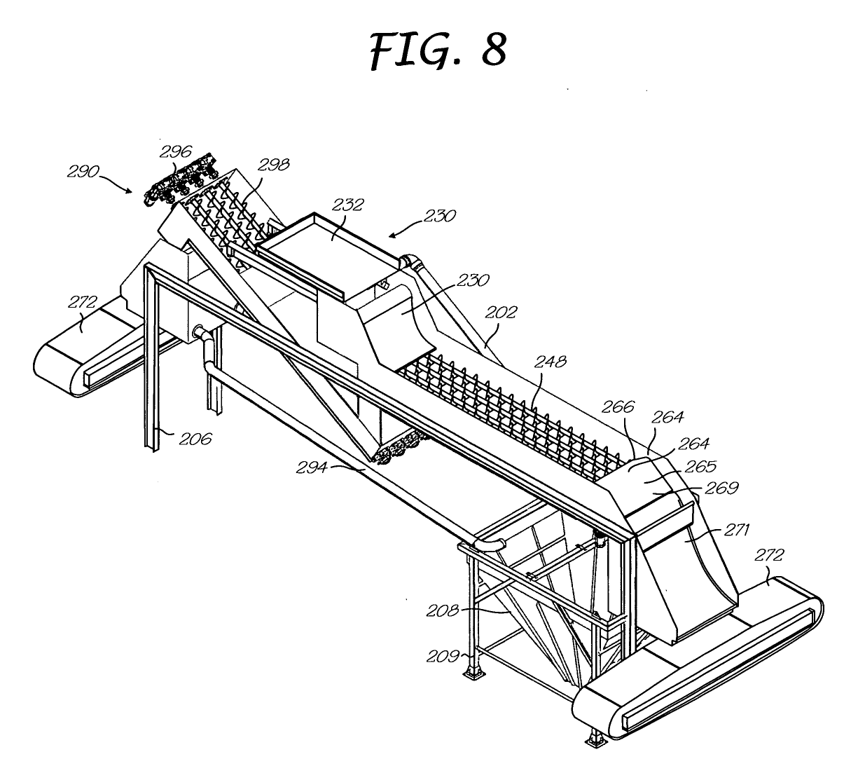

FIGS. 5-8 depict a dense medium separator for separating solids by specific gravity by establishing a float current in a suspension medium in the direction of a weir for evacuating a float fraction of solids and for moving a sink fraction of solids horizontally across the bottom of the bath in a direction counter to the float current in accordance with another exemplary embodiment of the present invention. FIG. 5 is a cross-sectional side view of the exemplary dense medium separator shown in FIG. 8 and FIG. 6 is a cross-sectional side view of the exemplary dense medium separator showing the opposite side. FIG. 7 is a front view of the exemplary dense medium, wherein the front is the evacuation end of the separator and FIG. 8 is an oblique view of separator 200. Separator 200 depicted in FIGS. 5-8 separates solids in a manner similar to that described above with regard to FIGS. 1-4, and therefore, only the distinctions between separator 100 and separator 200 will be described in detail.

Dense medium separator 200 generally comprises the same four independent and separate zones as discussed above with reference to separator 100, distribution zone 220, separation zone 240, evacuation zone 260 and recovery zone 280. The components in that comprise these zones, while sometimes different, serve the same purpose as the components in separator 100 and may be configured somewhat differently to achieve higher separation efficiency.

Distribution zone 220 is situated at one end of separation zone 240, and generally comprises distribution slide 234, which receives solids to be separated from vibration table 232 and the components for injecting medium 214. The solids are placed onto slide 234 and slide down into the medium in separation zone 240. The medium may be injected as described herein above or as described directly below. In accordance with one exemplary embodiment of the present invention, medium 214 is injected through a gap formed by lower outfall edge 236 of slide 234 and bottom 221 of distribution zone 220 (not shown). Here, lower outfall edge 236 may extend beneath the level of medium 214, but should be positioned above bottom 221 of distribution zone 220. Medium 214 is pumped behind slide 234 from injection pipe 202 diverted through the gap and into separation zone 240, thereby establishing the float current. It is envisioned that slide 234 is fabricated from a nonporous material causing the full injection current from injection pipe 202 through the gap. The width of the gap is approximately equal to the width of separation zone 240, designated as w_{sz}, to ensure an even float current across the separation zone with the solids deposited thereon by vibration table 232. Conversely, slide 234 may be constructed as a porous material with holes, slits or other flow diverters. In this instance, medium flows through the openings in the slide rather than underneath it.

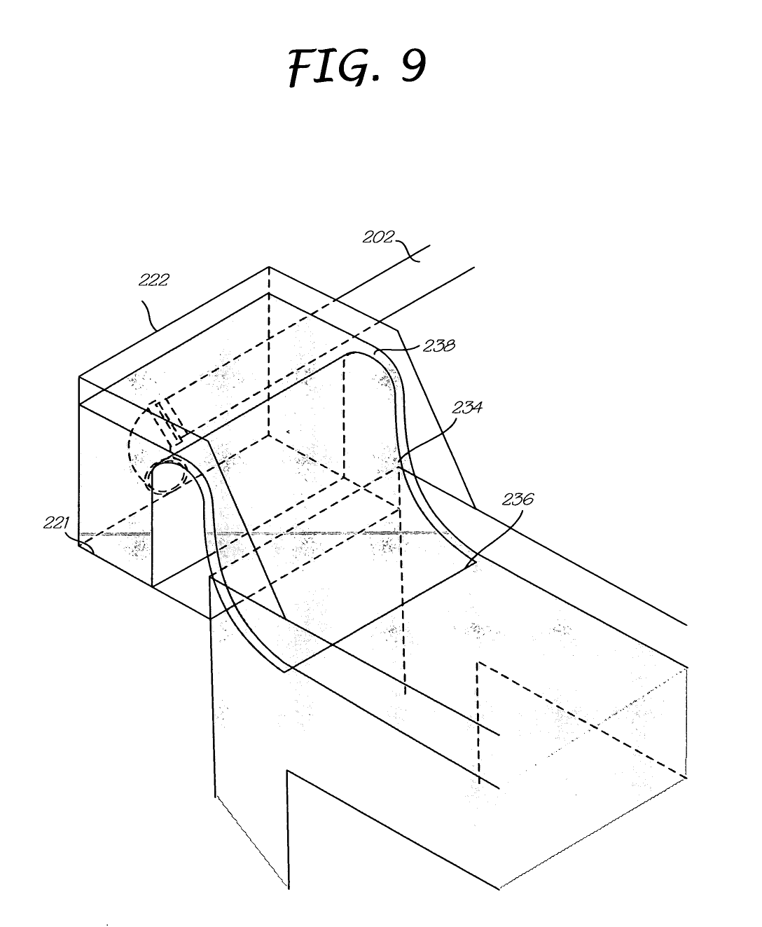

In accordance with yet another exemplary embodiment of the present invention, the full injection current from injection pipe 202 is forced over the upper extent of slide 234 and then follows the contour of the slide into the separation zone 240. Distribution volume 222 for this embodiment is depicted in FIG. 9 as an enlarged view. Here, slide 234 forms a curvilinear cross-sectional shape which extends from bottom 221 of the distribution zone to upper crest 238 and then fall off to form lower outfall edge 236. Slide 234 forms a water tight seal against the walls of distribution volume 222. In so doing, a distribution cavity is formed between the rear facing surface of slide 234 and the walls of distribution volume 222. Injection pipe 202 enters the distribution cavity near bottom 221 and medium 214 is pumped into the cavity. The cavity fills until medium 214 reaches the crest of slide 234. Crest 238 of slide 234 is substantially horizontal, so when the distribution cavity fills, medium 214 overflows the entire width, w_{sz}, across crest 238, resulting in distribution a slide weir above the crest. Medium 214 moves down slide 234 and directly into separation zone 240, with the solids deposited thereon by vibration table 232. In this exemplary embodiment, the length of the distribution zone 220 can be shortened over that discussed above with regard to FIGS. 1-4 while still retaining optimal laminar flow into separation zone 240, for two reasons. First, the distribution chamber has a calming effect on the medium, as the medium is lifted to the crest of the slide in the relatively large volume of the distribution cavity, turbulence induced by the pumping action is attenuated. Additionally, as the medium falls over slide crest 238, gravity propels the medium equally along front surface of slide 234 as a continuous, laminar sheet in the direction of evacuation.

Solids, both the fraction of sinks 212 and the fraction of floats 210, enter separation zone 240 as described immediately above and traverse separation zone 240 as described above with regard to FIGS. 1-4. Separation occurs in separation volume 242 and floats 210 proceed to evacuation zone 260. In evacuation zone 260, evacuation overflow barrier 265 extends laterally between the walls of separation zone 240 and vertically from the bottom of the separation zone. Overflow barrier 265 presents resistance to the flow which is overcome with a volume of medium sufficient to create a hydrostatic head greater than the height of the barrier, whereby medium 214 overflows overflow barrier 265 forming weir 264. In accordance with one exemplary embodiment of the present invention, evacuation overflow barrier 265 is a broad crest type of barrier, having a generally V-shaped cross section with tapered upstream side 266, adjacent to separation zone 240 and tapered overflow side 269 on the recovery side of evacuation upper crest 267 and a broad crest therebetween. Barrier crest 267 has a gentle contour transiting from tapered upstream side 266 to tapered overflow side 269. This gentle slope facilities floats 210 evacuating separation zone 240 by preventing the floats from piling-up at weir 264. Both tapered upstream side 266 and tapered overflow side 269 may be substantially planar, or may take a more aerodynamic curve, such as an ogee. Floats splash guard 275 may also be provided at the lower end of tapered evacuation outfall 269 to redirect any spray and spatter of medium and floats back toward floats recovery dewatering device 271.

Medium 214 and floats 210 exit evacuation zone 260, over weir 264 and onto tapered overflow side 269 which deposits the floats and medium on floats recovery dewatering device 271. The purpose of floats recovery dewatering device 271 is to dewater and optionally rinse the floats as they proceed on their path to floats transport 272, which conveys the floats on for further processing. Therefore, in accordance with one exemplary embodiment of the present invention, floats recovery dewatering device 271 may be fashioned as a mesh or similar structure with a relatively fine mesh opening size in order to separate the smallest sized solids from the medium. Once on floats recovery dewatering device 271, floats 210 traverse the dewatering device while medium 214 falls through the sieve openings and into medium recovery basin 273. Dewatering device 271 may be 1) flat but horizontally upwardly or downwardly inclined as in the case of a vibratory screen, 2) concave or bent as in the case of a sieve bend, 3) concave and horizontal as in the case of a banana-screen, 4) or round as in the case of a rotary trommel or scrubber-rinser. Accordingly, the dewatering devices for use with the present invention may be static, vibratory or rotating.

Notice that a portion of medium recovery basin 273 is positioned directly over medium tank 208, which is opened to allow medium 214 collected in recovery basin 273 to fall directly into recovery tank 208. Recovery tank 208 will receive medium from two sources, floats evacuation dewatering device 271 portion of floats recovery assembly 270 and sinks recovery dewatering device 291 portion of sinks recovery device 280. Optimally, recovery tank 208 is positioned proximate to floats recovery assembly 270, under medium recovery basin 273 to reduce the amount of plumping necessary as the volume of medium exiting separator 200 over weir 264 greatly exceed the volume of medium being dewatered by sinks recovery dewatering device 291. Pump 207 recirculates medium 214 returned to medium tank 208 back to distribution zone 220 via injection pipe 202.

As mentioned elsewhere above, separation occurs in separation zone 240, typically within the unperturbed region, with sinks 212 falling to the bottom of the separation. There, sinks mover 248 moves the sinks horizontally across the bottom of the separator in an opposite direction of the flow current, i.e., in the direction of a counter-current. Sinks mover 248 may be any device capable of moving the sinks and which may also create a gentle counter-current, not just the exemplary sinks auger. As also mentioned above, the sinks are not lifted across separation zone 240 as is common in prior art separators, but the sinks are moved completely out of the separation zone before they are lifted out of the bath.

In accordance with still another exemplary embodiment of the present invention, sinks 212 are lifted out of recovery zone 280 in the same direction as the counter-current, but spatially separated from the separation zone, thereby further reducing turbulence and perturbations in separation zone 240. Notice from FIGS. 5-8 that sinks recovery assembly 290 is oriented in the same direction as sinks mover 248 in recovery zone 280, thus the lifting operation assists in the establishment of the counter-current. Furthermore, sinks recovery assembly 290 is remotely positioned from the separation zone, by the difference of the length of recovery zone 280 to that to the length of separation zone 240 (l_{rz}−l_{sz}). Here again, sinks recovery device 298 is depicted as an auger but may be any type of lifting device.

Sinks recovery device 298 lifts sinks 212 out of the bath along with some medium 214. Sinks are lifted in the direction of the counter-current by sinks recovery device 298, which fall out onto sinks recovery dewatering device 291. Here again, recovery device 298 and sinks mover 248 are typically independent from each other and capable of being operated at different rates, or alternatively the two may be mechanically coupled or even extension of the same device, such as a continuous belt. In accordance with still another exemplary embodiment of the present invention, sinks recovery dewatering device 291 is fashioned as a mesh with a relatively fine slot opening size in order to accommodate the smallest sized sinks to be separated on the separator, or similarly to floats recovery dewatering device 271. Once deposited on sinks recovery dewatering device 291, sinks 212 traverse the dewatering device while the medium falls through the sieve openings and into sinks medium recovery basin 293. A splash guard 275 may also be provided proximate to sinks recovery dewatering device 291 to redirect any spray and spatter of medium and sinks back toward sinks recovery dewatering device 291. Medium collected in basin 293 is redirected back to tank 208 by pipes 294.

Below are some exemplary tables for estimating the dimensions and operational parameters for the presently described separators. Care should be exercised in their use as the values are estimations that should be verified during operation.

TABLE I

| solids type | Coal | Beets | Potatoes |
|---|---|---|---|
| width of separator in feet | 4 | 4 | 4 |
| width of separator in meters | 1.2192 | 1.2192 | 1.2192 |
| surface density of solids in | 60 | 50 | 33 |
| kgs/m² | | | |
| surface density of solids in | 0.060 | 0.050 | 0.033 |
| tons/m² | | | |
| separator speed in meters/hour | 2,270 | 2,780 | 2,270 |
| separator speed in meters/ | 0.6306 | 0.7722 | 0.6306 |
| second | | | |
| capacity in tons | 166.06 | 169.47 | 91.33 |
| weir height ratio | 1.0 | 1.0 | 1.0 |
| maximum solids diameter in | 100 | 150 | 100 |
| mm | | | |
| weir height required in mm | 100.00 | 150.00 | 100.00 |
| weir height required in meters | 0.100 | 0.150 | 0.100 |
| minimum flow of medium in | 276.76 | 508.41 | 276.76 |
| m³/hour | | | |
| true density of solids | 1.3 | 1.02 | 1.08 |
| volume of solids in m³/hour | 127.73 | 166.15 | 84.57 |
| total volume entering | 404.49 | 674.55 | 361.32 |
| ratio of medium to solids by | 2.17 | 3.06 | 3.27 |
| volume | | | |
| residence time required in | 6.50 | 6.50 | 6.50 |
| seconds | | | |
| length of separator in meters | 4.10 | 5.02 | 4.10 |
| actual weir height in mm | 100.02 | 150.02 | 100.02 |
| actual weir height in meters | 0.100 | 0.150 | 0.100 |

TABLE II

| solids type | Billets | Carrots | Peas |
|---|---|---|---|
| width of separator in feet | 4 | 4 | 4 |
| width of separator in meters | 1.2192 | 1.2192 | 1.2192 |
| surface density of solids in | 12.5 | 12.5 | 4 |
| kgs/m² | | | |
| surface density of solids in | 0.013 | 0.013 | 0.004 |
| tons/m² | | | |
| separator speed in meters/hour | 1,015 | 1,015 | 556 |
| separator speed in meters/second | 0.2819 | 0.2819 | 0.1544 |
| capacity in tons | 15.47 | 15.47 | 2.71 |
| weir height ratio | 1.0 | 1.0 | 1.0 |
| maximum solids_diameter in | 20 | 20 | 6 |
| mm | | | |
| weir height required in mm | 20.00 | 20.00 | 6.00 |
| weir height required in meters | 0.020 | 0.020 | 0.006 |
| minimum flow of medium in | 24.75 | 24.75 | 4.07 |
| m³/hour | | | |
| true density of solids | 1.09 | 1.04 | 1.05 |
| volume of solids in | 14.19 | 14.87 | 2.58 |
| m³/hour | | | |
| total volume entering | 38.94 | 39.62 | 6.65 |
| ratio of medium to solids by | 1.74 | 1.66 | 1.58 |
| volume | | | |
| residence time required in | 6.50 | 6.50 | 6.50 |
| seconds | | | |
| length of separator in meters | 1.83 | 1.83 | 1.00 |
| actual weir height in mm | 20.00 | 20.00 | 6.00 |
| actual weir height in meters | 0.020 | 0.020 | 0.006 |

TABLE III

| Solids | | Solids + Medium | |
|---|---|---|---|
| length of separation zone in feet | 13 | ratio of medium to solids | 5 |
| length of separation zone in meters | 3.962 | total volume medium in m³ per hour | 251.46 |
| width of separation zone in feet | 5 | average density of floats | 1.050 |
| width of separation zone in meters | 1.524 | volume of solids | 47.90 |
| surface density in kgs/m² | 33 | total volume solids + medium | 299.36 |
| surface density in tons/m² | 0.033 | weir height in meters without reduction | 0.091 |
| tonnage solids on separator surface | 0.199 | volume of working area | 0.548 |
| capacity in tons per meter width | 33 | weir reduction | 2 |
| total tonnage per hour | 50.29 | exit weir width | 0.762 |
| cycles per hour | 252 | weir height with reduction | 0.144 |
| meters per hour | 1,000 | cycles per hour | 546 |
| | | meters per hour | 2,163 |

TABLE IV

| solids type | Coal | Beets | Potatoes |
|---|---|---|---|
| length of separation zone in feet | 10.93 | 10.93 | 10.93 |
| length of separation zone in meters | 3.331 | 3.331 | 3.331 |
| width of separation zone in feet | 3.28 | 3.28 | 3.28 |
| width of separation zone in meters | 1.000 | 1.000 | 1.000 |
| surface density in kgs/m² | 100.0 | 50.0 | 33.0 |
| surface density in tons/m² | 0.1000 | 0.0500 | 0.0330 |
| maximum tonnage of solids on separator surface | 0.3331 | 0.1665 | 0.1099 |
| surface density to capacity multiplier | 1,888 | 1,888 | 1,888 |
| capacity in TPH per meter width of separator | 188.8 | 94.4 | 62.3 |
| total capacity of separator in TPH | 188.75 | 94.38 | 62.29 |
| minimum cycles per hour | 567 | 567 | 567 |
| minimum speed in meters per hour | 1,888 | 1,888 | 1,888 |
| minimum speed in meters per minute | 31.47 | 31.47 | 31.47 |
| minimum speed in meters per second | 0.524 | 0.524 | 0.524 |
| maximum residence time in seconds | 6.35 | 6.35 | 6.35 |
| ratio of medium to solids by volume | 2.12 | 2.12 | 2.12 |
| cubic meters medium per hour | 307.81 | 190.55 | 125.76 |
| average density of floats | 1.300 | 1.050 | 1.050 |
| cubic meters solids per hour fed to separator | 145.19 | 89.88 | 59.32 |
| total cubic meters of solids + medium | 453.00 | 280.43 | 185.08 |
| weir height in meters without reduction | 0.159 | 0.115 | 0.087 |
| volume in cubic meters above weir | 0.528 | 0.384 | 0.291 |
| weir reduction | 2 | 2 | 2 |
| weir width after reduction | 0.499872 | 0.499872 | 0.499872 |
| weir height in meters with reduction | 0.252 | 0.183 | 0.139 |
| actual cycles per hour | 858 | 731 | 637 |
| actual speed in meters per hour | 2,858 | 2,436 | 2,121 |
| actual speed in meters per minute | 47.63 | 40.59 | 35.34 |
| actual speed in meters per second | 0.794 | 0.677 | 0.589 |
| actual residence time in seconds | 4.20 | 4.92 | 5.66 |

TABLE V

| | Billets | Carrots | Peas | Plastic |
|---|---|---|---|---|
| length of separation zone in feet | 10.93 | 10.93 | 10.93 | 10.93 |
| length of separation zone in meters | 3.331 | 3.331 | 3.331 | 3.331 |
| width of separation zone in feet | 3.28 | 3.28 | 3.28 | 3.28 |
| width of separation zone in meters | 1.000 | 1.000 | 1.000 | 1.000 |
| surface density in kgs/m² | 12.5 | 12.5 | 5.0 | 2.5 |
| surface density in tons/m² | 0.0125 | 0.0125 | 0.0050 | 0.0025 |
| maximum tonnage of solids on separator surface | 0.0416 | 0.0416 | 0.0167 | 0.0083 |
| surface density to capacity multiplier | 1,888 | 1,888 | 1,888 | 1,888 |
| capacity in TPH per meter width of separator | 23.6 | 23.6 | 9.4 | 4.7 |
| total capacity of separator in TPH | 23.59 | 23.59 | 9.44 | 4.72 |
| minimum cycles per hour | 567 | 567 | 567 | 567 |
| minimum speed in meters per hour | 1,888 | 1,888 | 1,888 | 1,888 |
| minimum speed in meters per minute | 31.47 | 31.47 | 31.47 | 31.47 |
| minimum speed in meters per second | 0.524 | 0.524 | 0.524 | 0.524 |
| maximum residence time in seconds | 6.35 | 6.35 | 6.35 | 6.35 |
| ratio of medium to solids by volume | 2.12 | 2.12 | 2.12 | 2.12 |
| cubic meters medium per hour | 47.64 | 47.64 | 19.05 | 9.53 |
| average density of floats | 1.050 | 1.050 | 1.050 | 1.050 |
| cubic meters solids per hour fed to separator | 22.47 | 22.47 | 8.99 | 4.49 |
| total cubic meters of solids + medium | 70.11 | 70.11 | 28.04 | 14.02 |
| weir height in meters without reduction | 0.046 | 0.046 | 0.025 | 0.016 |
| volume in cubic meters above weir | 0.152 | 0.152 | 0.083 | 0.052 |
| weir reduction | 2 | 2 | 2 | 2 |
| weir width after reduction | 0.499872 | 0.499872 | 0.499872 | 0.499872 |
| weir height in meters with reduction | 0.073 | 0.073 | 0.039 | 0.025 |
| actual cycles per hour | 461 | 461 | 339 | 269 |
| actual speed in meters per hour | 1,534 | 1,534 | 1,130 | 897 |
| actual speed in meters per minute | 25.57 | 25.57 | 18.84 | 14.95 |
| actual speed in meters per second | 0.426 | 0.426 | 0.314 | 0.249 |
| actual residence time in seconds | 7.82 | 7.82 | 10.61 | 13.37 |

TABLE VI
Terminal Velocity of Solids
(Graphically represented in FIG. 8)

| Density | mm |
|---|---|
| 1.000 | 0 |
| 1.001 | 54.20 |
| 1.002 | 76.65 |
| 1.003 | 93.88 |
| 1.004 | 108.41 |
| 1.005 | 121.20 |
| 1.006 | 132.77 |
| 1.007 | 143.41 |
| 1.008 | 153.51 |
| 1.009 | 162.61 |
| 1.010 | 171.40 |
| 1.010 | 171.40 |
| 1.015 | 209.93 |
| 1.020 | 242.40 |
| 1.025 | 272.01 |
| 1.030 | 296.88 |
| 1.035 | 320.69 |
| 1.040 | 342.81 |
| 1.045 | 363.60 |
| 1.050 | 383.27 |
| 1.055 | 401.98 |
| 1.060 | 419.85 |
| 1.065 | 437.00 |
| 1.070 | 453.49 |
| 1.075 | 469.41 |
| 1.080 | 484.81 |
| 1.085 | 499.73 |
| 1.090 | 514.21 |

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

What is claimed is:

1. A device for separating solids by density comprising:
a quiescent bath of medium, said quiescent bath comprises at least a separation zone wherein a fraction of float solids are separated from a fraction of sink solids;
a medium distribution device to generate a float current of medium in a first direction of the quiescent bath;
a solids distribution device to deposit solids into the quiescent bath, the solids comprising the fraction of float solids and the fraction of sink solids;
an outflow device to receive at least a portion of the float current and to outflow the at least a portion of the float current and the float solids from the quiescent bath;
a sinks solids device to move the sink solids in a direction opposite the float current; and
a lift device to lift the sink solids from the quiescent bath.

2. The device recited in claim 1, wherein the float current occupies an upper stratum of medium of the quiescent bath in the separation zone.

3. The device recited in claim 2, wherein the sink solids device is positioned at in a second stratum of medium of the quiescent bath below the separation zone.

4. The device recited in claim 2, wherein the sinks solids device generates a counter-current in a second stratum below the separation zone.

5. The device recited in claim 3, further comprises:
a float solids dewatering device adjacent to the outflow device, said float solids dewatering device having openings for passing medium without passing the float solids.

6. The device recited in claim 3, wherein the medium distribution device further comprises a plurality of injection nozzles.

7. The device recited in claim 3, wherein the solids distribution device further comprises a vibration table and a slide.

8. The device recited in claim 7, wherein the medium distribution device further comprises a compartment having the slide as one compartment wall, and an injection pipe to inject medium into the compartment, wherein medium overflows the slide and into the quiescent bath of medium and generating the float current.

9. The device recited in claim 3, wherein the separation zone further comprises a third stratum of unperturbed medium, the third stratum is below the first stratum and above the second stratum.

10. The device recited in claim 3, wherein the sink solids device is one of an auger, scroll, scraper, scraper chain, belt, paddle, paddle belt and pump.

11. A method for separating solids by density comprising:
generating a floats current in a first direction of a quiescent bath of medium;
establishing a counter-current below the float current, the counter current being substantially opposite to the first direction;
depositing a fraction of float solids and a fraction of sink solids in the float current;
extracting the float solids from the float current; and
recovering the sink solids from the counter-current.

12. The method recited in claim 11 further comprises:
simultaneously dewatering the medium from the extracted float solids and directing the extracted float solids to a transport.

13. The method recited in claim 12 further comprises:
simultaneously dewatering the medium from the recovered sink solids and directing the recovered sink to a transport.

14. The method recited in claim 13, wherein depositing a fraction of float solids and a fraction of sink solids in the float current further comprises vibrating the fraction of float solids and the fraction of sink solids.

15. The method recited in claim 14, further comprises:
establishing a region of unperturbed medium between the float current and the counter-current.

16. The method recited in claim 13, further comprises;
circulating the dewatered medium into the float current.

17. A dense medium separator for separating solids by density comprising:
a bath for holding medium, the bath having a separation zone for separation of solids by density;
an injection device to generate a float current of medium in a first direction of the bath;
a vibration table to tamp a heterogeneous distribution of solids, the solids comprises a fraction of sinks and a fraction of solids;
a slide to redirect the solids;
a weir to evacuate the floats from the bath;
a sinks mover to move the sinks horizontally, in a direction opposite the float current; and
a lift device to recover the sinks from the bath.

18. The dense medium separator recited in claim 17, wherein a depth of the separation zone is at least quadruple a depth of medium over the weir.

19. The dense medium separator recited in claim 17, wherein the sinks solids device and the lift device comprise any of an auger, scroll, scraper, scraper chain, belt, paddle, paddle belt and pump.
